(19) United States
(12) Patent Application Publication
(10) Pub. No.: US 2025/0117923 A1
(43) Pub. Date: Apr. 10, 2025

(54) INFORMATION PROCESSING APPARATUS, INFORMATION PROCESSING METHOD, AND NON-TRANSITORY COMPUTER-READABLE MEDIUM

(71) Applicant: CANON KABUSHIKI KAISHA, Tokyo (JP)

(72) Inventor: YUJI KOBAYASHI, Kanagawa (JP)

(21) Appl. No.: 18/907,360

(22) Filed: Oct. 4, 2024

(30) Foreign Application Priority Data
Oct. 6, 2023 (JP) 2023-174628

(51) Int. Cl. G06T 7/00; H04L 9/32

(52) U.S. Cl. CPC G06T 7/0008; H04L 9/3236; G06T 2207/30132

(57) ABSTRACT

An information processing apparatus is provided. The apparatus detects a defect in a structure based on an image of the structure and generates defect data indicating a detection result. The apparatus calculates a hash value of the defect data. The apparatus records the defect data and the calculated hash value of the defect data. The apparatus performs first obtainment processing of obtaining the recorded defect data and the recorded hash value of the defect data. The apparatus performs first calculation processing of calculating a hash value of the defect data obtained in the first obtainment processing. The apparatus compares the hash value of the defect data calculated in the first calculation processing with the hash value of the defect data obtained in the first obtainment processing.

### BACKGROUND

### Field

The present disclosure relates to an information processing apparatus, an information processing method, and a non-transitory computer-readable medium, and particularly relates to the management of inspection data for a structure.

### Description of the Related Art

Inspections are an essential part of the maintenance of structures in public infrastructure, such as bridges, tunnels, and dams. Methods have therefore been proposed for detecting defects such as cracks from images captured of surfaces and the like of a structure serving as an inspection target. Recent improvements in the performance of computers and detection performance have made it possible to automatically detect defects from images, which in turn improves the efficiency of inspection tasks. For example, International Publication No. 2017/217185 discloses a method for capturing images of the surface of a large structure such as a concrete structure in sections, detecting defects such as cracks from a composite image, and generating an inspection result as a form.

### SUMMARY

According to an embodiment, an information processing apparatus comprises one or more memories storing instructions and one or more processors. The one or more processors execute the instructions to detect a defect in a structure based on an image of the structure and generate defect data indicating a detection result; calculate a hash value of the defect data; record the defect data and the calculated hash value of the defect data; perform first obtainment processing of obtaining the recorded defect data and the recorded hash value of the defect data; perform first calculation processing of calculating a hash value of the defect data obtained in the first obtainment processing; and verify whether the defect data obtained in the first obtainment processing has been altered by comparing the hash value of the defect data calculated in the first calculation processing with the hash value of the defect data obtained in the first obtainment processing.

According to another embodiment, an information processing method comprises detecting a defect in a structure based on an image of the structure and generating defect data indicating a detection result; calculating a hash value of the defect data; recording the defect data and the calculated hash value of the defect data; performing first obtainment processing of obtaining the recorded defect data and the recorded hash value of the defect data; performing first calculation processing of calculating a hash value of the defect data obtained in the first obtainment processing; and verifying whether the defect data obtained in the first obtainment processing has been altered by comparing the hash value of the defect data calculated in the first calculation processing with the hash value of the defect data obtained in the first obtainment processing.

According to still another embodiment, a non-transitory computer-readable medium stores computer-executable instructions that, when executed by a computer, cause the computer to perform a method comprising: detecting a defect in a structure based on an image of the structure and generating defect data indicating a detection result; calculating a hash value of the defect data; recording the defect data and the calculated hash value of the defect data; performing first obtainment processing of obtaining the recorded defect data and the recorded hash value of the defect data; performing first calculation processing of calculating a hash value of the defect data obtained in the first obtainment processing; and verifying whether the defect data obtained in the first obtainment processing has been altered by comparing the hash value of the defect data calculated in the first calculation processing with the hash value of the defect data obtained in the first obtainment processing.

Further features of various embodiments will become apparent from the following description of exemplary embodiments (with reference to the attached drawings).

### BRIEF DESCRIPTION OF THE DRAWINGS

FIG. 1 is a block diagram illustrating an example of the hardware configuration of an information processing apparatus according to one embodiment.

FIG. 2 is a diagram illustrating an example of the configuration of an inspection processing system according to one embodiment.

FIG. 3 is a diagram illustrating an example of the software configuration of a server apparatus according to one embodiment.

FIG. 4 is a diagram illustrating an example of a defect detected from an image.

FIG. 5 is a diagram illustrating an example of defect data.

FIG. 6 is a diagram illustrating an example of deleted data.

FIG. 7 is a diagram illustrating an example of difference determination data.

FIG. 8 is a diagram illustrating an example of inspection processing transaction data.

FIG. 9 is a diagram illustrating an example of alteration verification record data.

FIG. 10 is a diagram illustrating an example of corrected defect data.

FIGS. 11A to 11M are diagrams illustrating examples of screens in an inspection app.

FIG. 12 is a flowchart illustrating an information processing method according to one embodiment.

FIG. 13 is a flowchart illustrating alteration verification processing according to one embodiment.

FIG. 14 is a diagram illustrating an example of the software configuration of a server apparatus according to one embodiment.

FIG. 15 is a flowchart illustrating alteration verification processing according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but limitation is not made to embodiments that require all such features, and multiple such features may be combined as appropriate. Furthermore, in the attached drawings, the same reference numerals are given to the same or similar configurations, and redundant description thereof is omitted.

In International Publication No. 2017/217185, a client-server system is used, where a user terminal sends processing requests for each process, such as detecting cracks and generating forms, after which a server apparatus performs those processes in response to the processing requests and then sends the processing results to the user terminal. However, this document does not take into account the authenticity of, and the possibility of alterations to, the data generated in each process and the forms indicating the inspection results.

The present disclosure makes it possible to manage data generated in processing for inspecting a structure such that alterations to the managed data can be detected.

In the present specification, “defects” include cracks, for example. Cracks can form in the concrete surfaces of concrete structures such as automobile roads, bridges, tunnels, dams, and the like, due to damage, deterioration, and other factors. Such cracks form in the wall surfaces and the like of structures due to deterioration over time, shocks from earthquakes, and the like. A crack is a line-shaped break having a starting point, an ending point, a length, and a width. However, the type of the defect is not limited to a crack. For example, the defect may be materials separating from each other, water leakage, efflorescence, or the like.

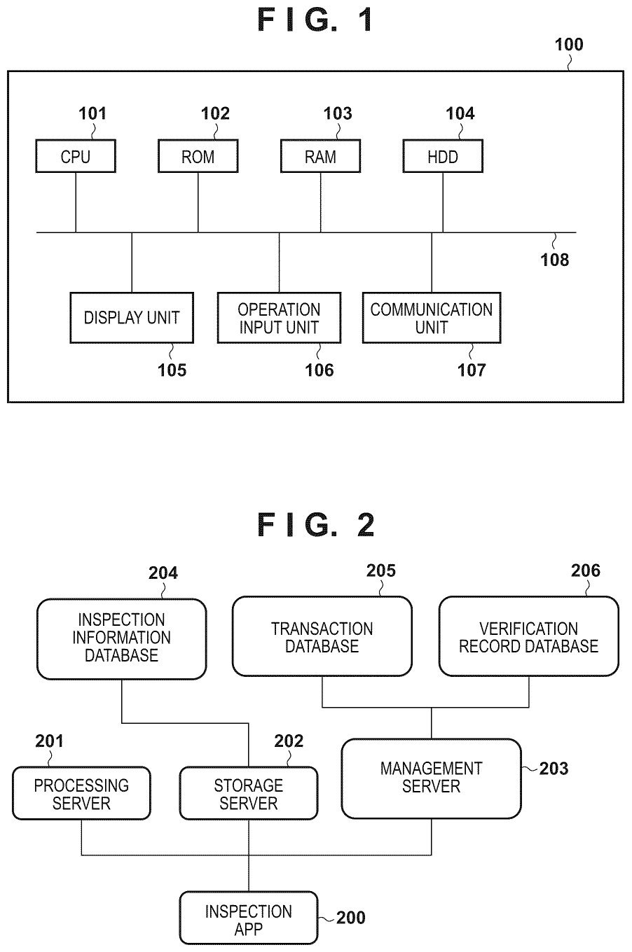

An information processing apparatus according to one embodiment can be realized by a computer apparatus including a processor and a memory. FIG. 1 is a block diagram illustrating an example of the hardware configuration of an information processing apparatus 100 according to one embodiment. Note that the processing performed by the information processing apparatus 100 may be implemented by a single computer apparatus. However, the processing performed by the information processing apparatus 100 may instead be implemented by a plurality of computer apparatuses. In this case, the functions of the information processing apparatus 100 can be distributed throughout the plurality of computer apparatuses. The plurality of computer apparatuses are connected to each other so as to be able to communicate.

The information processing apparatus 100 includes a CPU 101, a ROM 102, a RAM 103, an HDD 104, a display unit 105, an operation input unit 106, a communication unit 107, and a system bus 108.

The CPU 101 comprehensively controls the information processing apparatus 100 as a whole. The ROM 102 stores programs executed by the CPU 101, or parameters. The RAM 103 temporarily stores programs, data, and the like supplied from an external apparatus or the like. The HDD 104 is a storage medium. The HDD 104 is built in, or removably connected, to the information processing apparatus 100. A memory card may be used instead of the HDD 104. Also, an optical disk such as a DVD or a Blu-ray (registered trademark) disk, or a disk drive that reads data from and writes data to such a disk, may be used instead of the HDD 104.

The operation input unit 106 accepts user operations and outputs operation instructions to the CPU 101. The operation input unit 106 is an operation member such as a mouse, a keyboard, a touch panel, or the like, for example. The display unit 105 displays data held in the information processing apparatus 100 or data supplied from an external device. The display unit 105 is a display or a monitor that uses a technology such as LCD, organic EL, or the like. The communication unit 107 connects the information processing apparatus 100 to a network such as the Internet or a Local Area Network (LAN) such that it is as to be able to communicate therewith. The system bus 108 connects the units (101 to 107) of the information processing apparatus 100 to each other such that the units can exchange data with each other. The system bus 108 can include an address bus, a data bus, and a control bus.

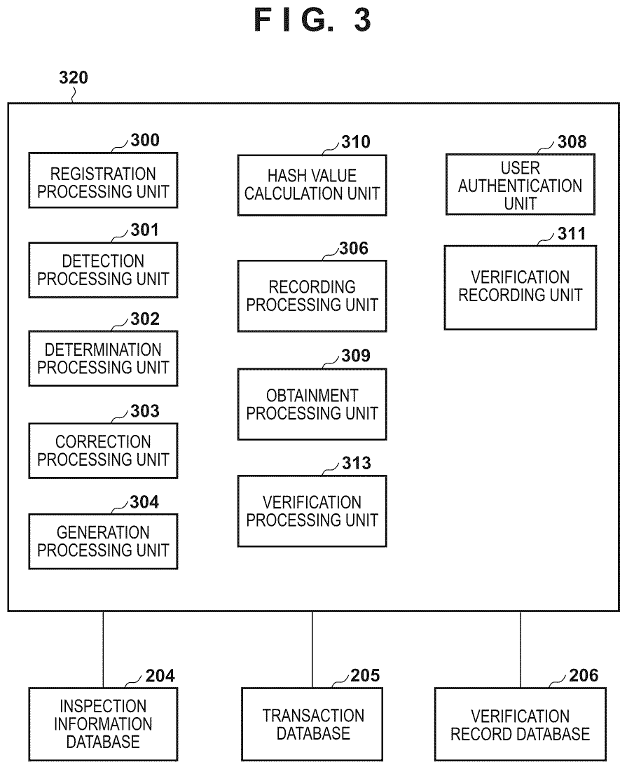

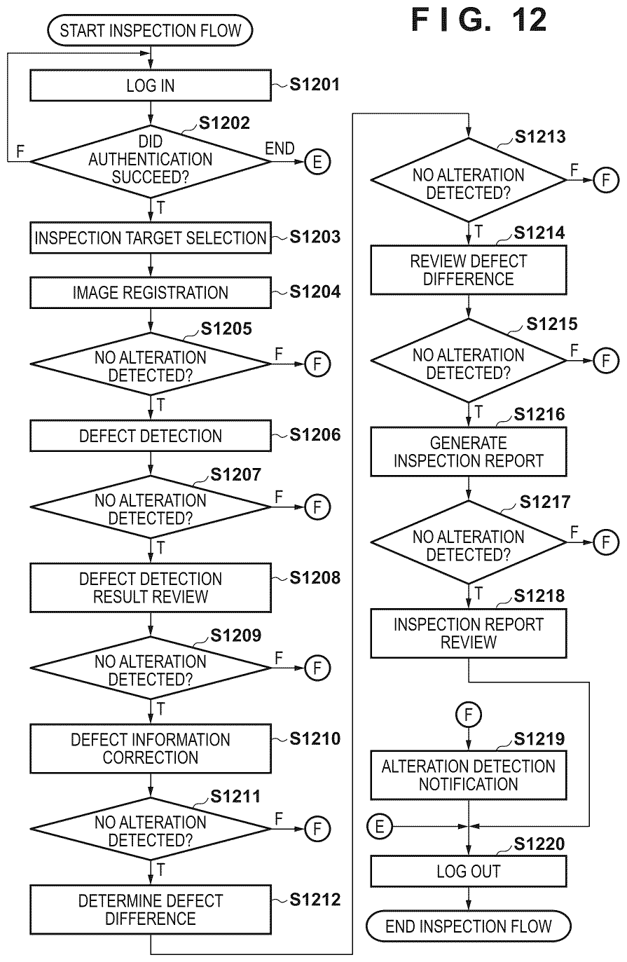

In this manner, a processor such as the CPU 101 executes programs stored in a memory such as the ROM 102, the RAM 103, or the HDD 104. These programs define the functions and processing of the information processing apparatus 100, which will be described later. Executing such programs implements the processing by the software configuration illustrated in FIG. 3 and the like and the processing indicated by the flowcharts in FIG. 12 and the like (described later).

In the embodiment described hereinafter, the ROM 102 stores programs for implementing the operations of an application, a processing server, a storage server, or a management server that implements structure inspection processing (described later). The ROM 102 also stores the software of an operating system (OS), which is basic software executed by the CPU 101, and software of an application for implementing adaptive functions by operating cooperatively with the OS. The processing by the information processing apparatus 100 according to the present embodiment is implemented by loading the software provided by these applications. The applications have software for using basic functions of the OS installed in the information processing apparatus 100. Note that the OS of the information processing apparatus 100 may have software for implementing the processing of the present embodiment.

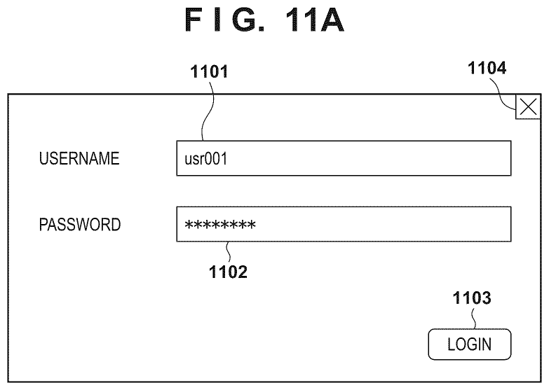

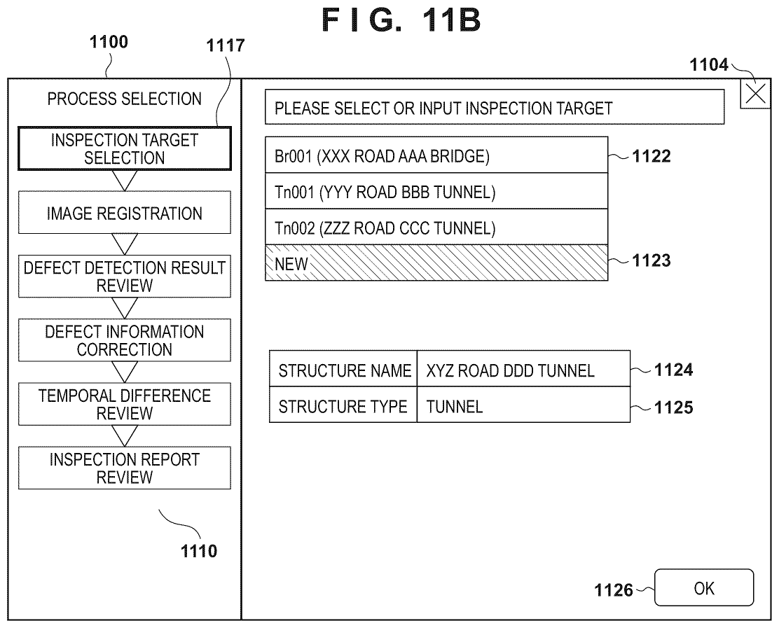

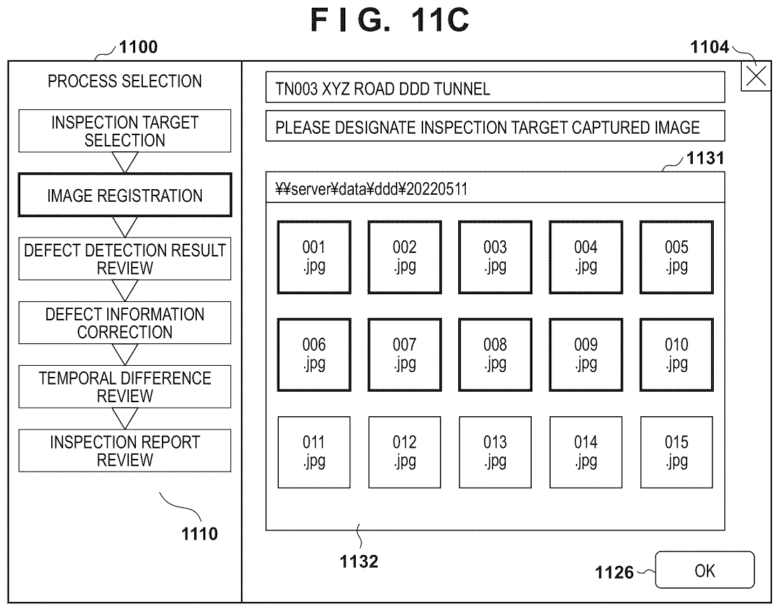

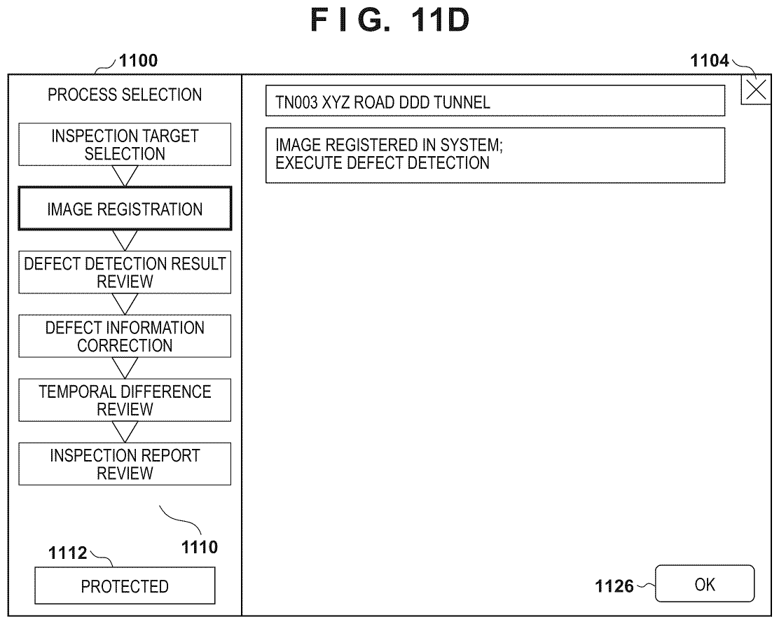

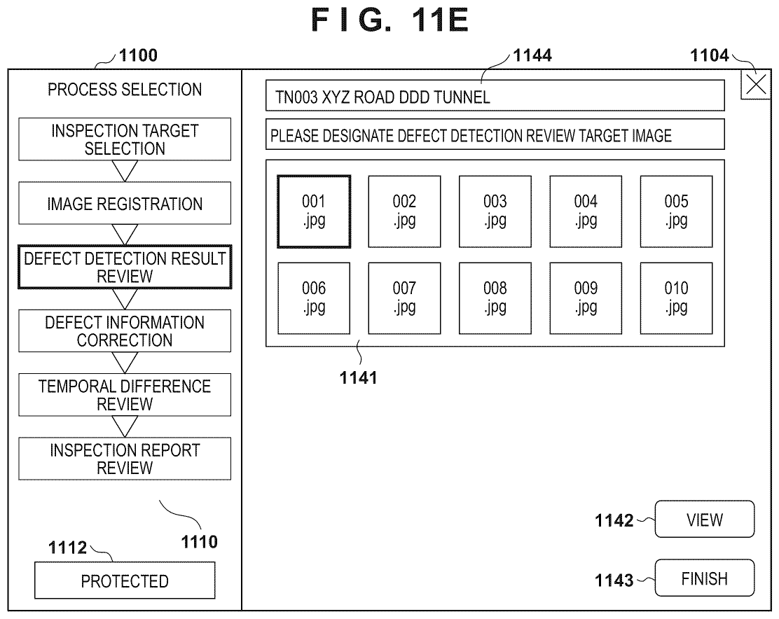

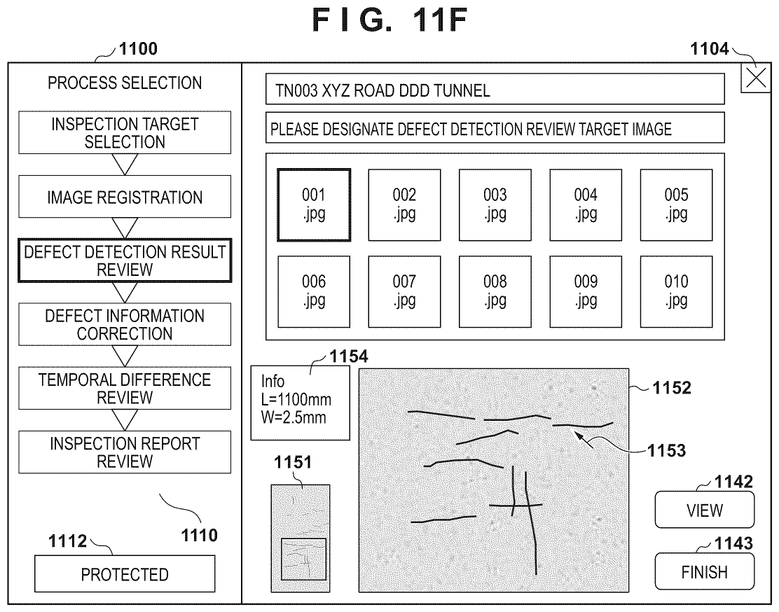

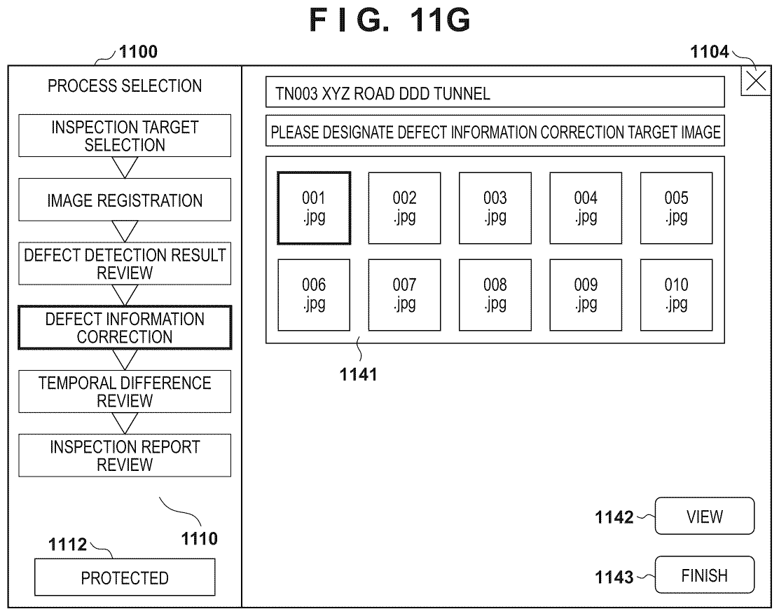

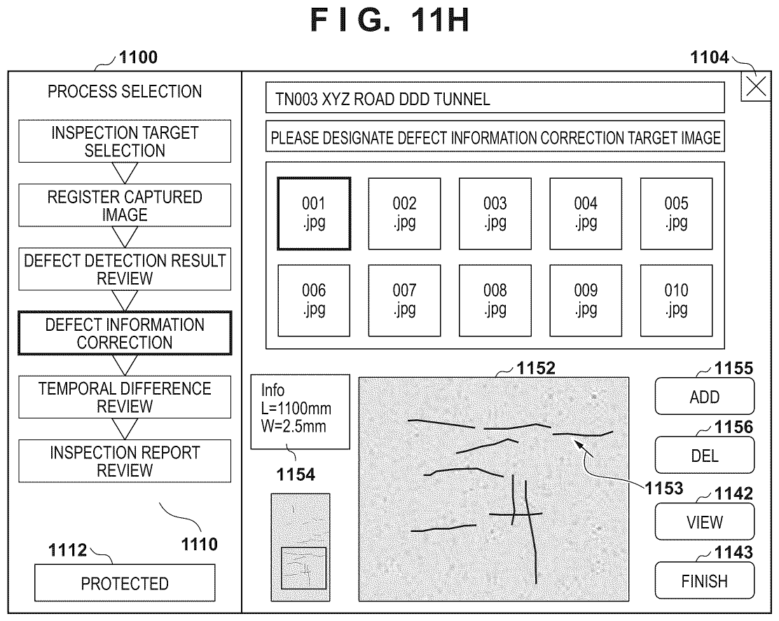

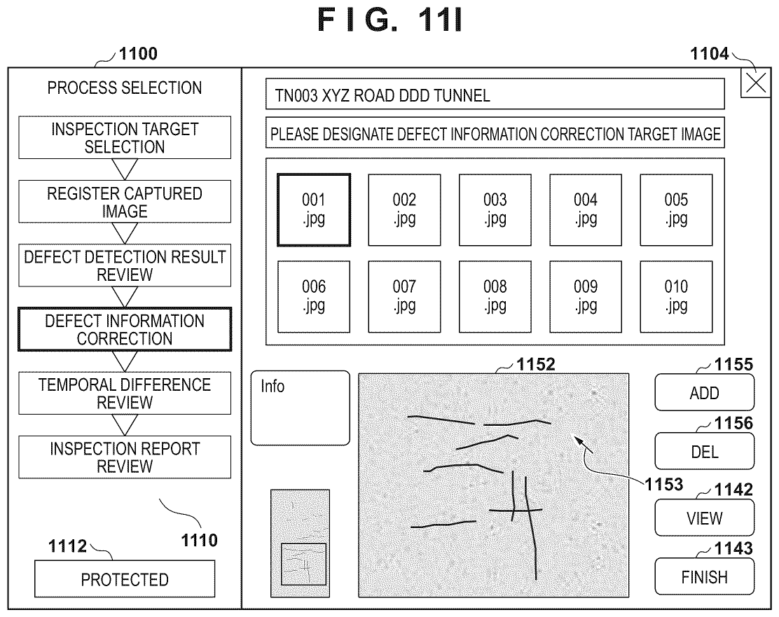

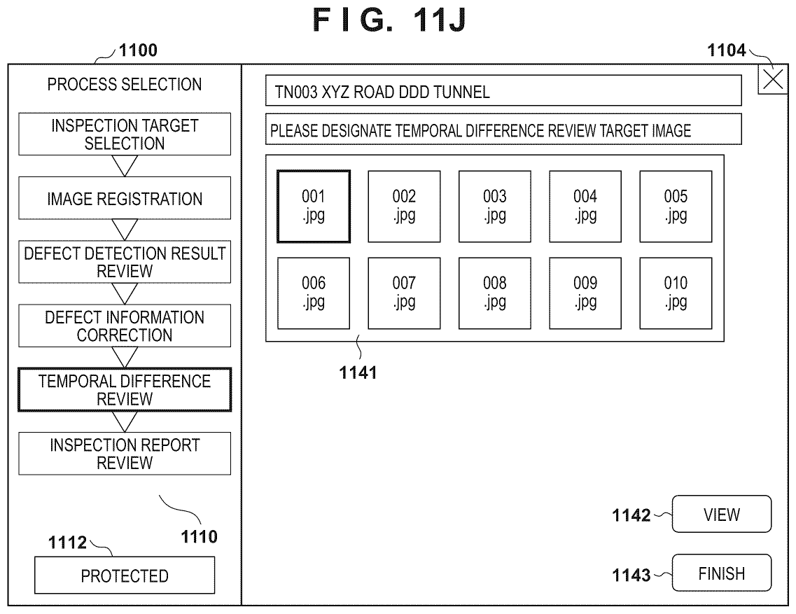

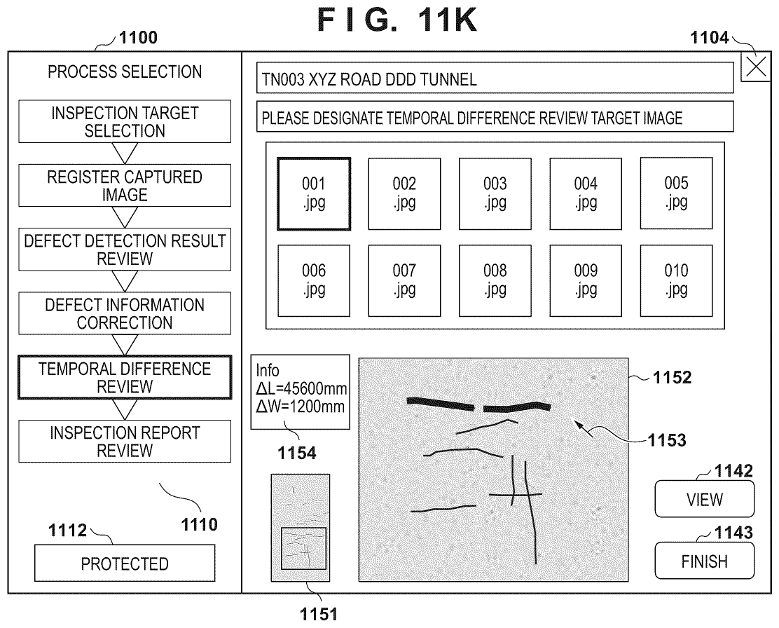

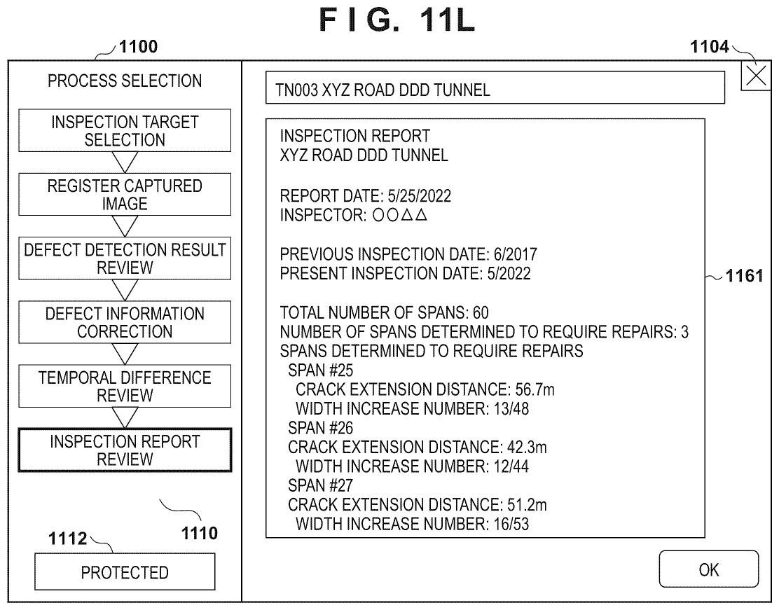

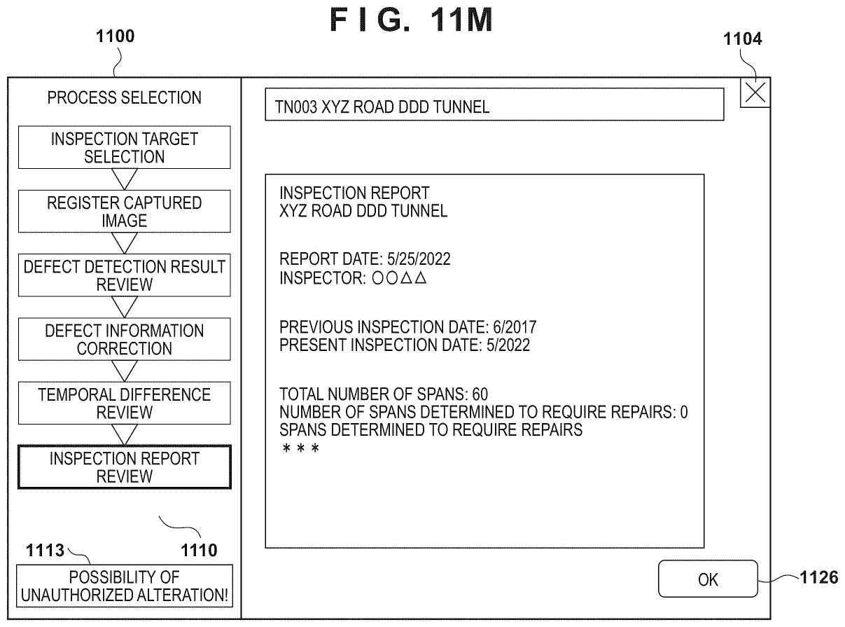

FIG. 2 illustrates an example of the configuration of an inspection processing system implemented by a plurality of the information processing apparatuses 100, according to one embodiment. The inspection processing system of the present embodiment includes a client apparatus and a server apparatus. The client apparatus is an information processing apparatus 100 that performs the processing of an inspection app 200. This inspection app 200 provides a user interface for performing interactive operations, which will be described later with reference to FIGS. 11A to 11M. The server apparatus is an information processing apparatus 100 that performs the processing of a processing server 201, a storage server 202, and a management server 203.

The storage server 202 is connected to an inspection information database 204. The storage server 202 performs processing for registering, searching for, and reading out various types of inspection data with respect to the inspection information database 204. In the present specification, “inspection data” refers to data recorded during processing for inspecting a structure. The inspection data includes defect data (described later). The inspection data can also include image data, deleted data, difference determination data, and inspection report data (also described later). The inspection information database 204 and the storage server 202 may be provided in the same information processing apparatus, or in different information processing apparatuses.

The management server 203 is connected to a transaction database 205 and a verification record database 206. The management server 203 performs processing for registering, searching for, and reading out inspection processing transaction data with respect to the transaction database 205. The management server 203 also performs various types of processing such as verifying transaction data. Furthermore, the management server 203 performs processing for registering, searching for, and reading out alteration verification record data with respect to the verification record database 206. In the present specification, “inspection processing transaction” refers to the generation, editing, and distribution of inspection data generated in a series of processes performed when inspecting a structure, which will be described later with reference to FIGS. 11A to 11M.

Note that these databases may be provided in public storage. For example, the databases may be implemented using cloud storage. The data stored in the databases may also be obtainable over the Internet. In such a configuration, the data can be identified by using a URL. In this case, the user of the client apparatus may be able to access the inspection data, such as images of the structure and defect data. As such, even if the inspection data is stored in public storage, alterations to the inspection data made by the user of the client apparatus or another user (described later) can be detected, and the reliability of the inspection data can therefore be improved.

FIG. 3 is a diagram illustrating an example of the software configuration of a server apparatus 320 according to one embodiment. The server apparatus 320 has the functions of the processing server 201, the storage server 202, and the management server 203. The software of this server apparatus 320 may be provided in a single information processing apparatus 100. However, the software may be distributed throughout a plurality of apparatuses. For example, the server apparatus 320, which is an information processing apparatus according to one embodiment, may be constituted by a plurality of information processing apparatuses connected over a network. Specifically, the processing server 201, the storage server 202, and the management server 203 may be implemented by individual information processing apparatuses 100. In this case, the processing server 201 may include a registration processing unit 300, a detection processing unit 301, a determination processing unit 302, a correction processing unit 303, and a generation processing unit 304.

The registration processing unit 300 accepts the registration of an image of a structure. For example, using the inspection app 200, the user can designate image data obtained by capturing an image of a structure to be taken as an inspection target. At this time, the registration processing unit 300 can register the designated image data in the system. For example, the registration processing unit 300 can obtain the image of the structure and store the image in the inspection information database 204. However, rather than storing the image data in the inspection information database 204, the registration processing unit 300 may register information indicating the storage location of the image data.

The detection processing unit 301 detects a defect in the structure based on the image of the structure. The detection processing unit 301 can detect a defect such as a crack from the image registered by the registration processing unit 300. The detection processing unit 301 may also detect attributes of the defect in the structure. Width, length, and the like can be given as examples of the attributes of a crack defect. However, the attributes of the defect are not limited thereto, and may include the surface area of the defect, for example. The detection processing unit 301 then generates defect data indicating the result of the detection.

In the present embodiment, the detection processing unit 301 can detect defects automatically through image analysis processing. Such image analysis processing may be performed using a learning model generated through machine learning or deep learning. However, the user may designate the location of a defect manually through a method such as tracing a shape on the image. In this case, the detection processing unit 301 can obtain information indicating the defect, input by the user in this manner. The defect data may also be generated through a combination of automatic detection and manual input.

The determination processing unit 302 determines a difference among defects indicated by a plurality of pieces of the defect data obtained by an obtainment processing unit 309. For example, the determination processing unit 302 can compare the defect data generated by the detection processing unit 301 with defect data that was generated based on images captured in the past of the same part of the same structure and that is registered in the inspection information database 204. The determination processing unit 302 can automatically compare two pieces of the defect data based on similarities between the locations and shapes thereof. In this manner, the determination processing unit 302 compares the defect detected by the detection processing unit 301 with a defect from the past and determines a difference in the defect. Such processing makes it possible to ascertain whether the detected defect is a new defect or a defect that was already present. The determination processing unit 302 can also determine whether the area where the defect is present is deteriorating over time. The defect comparison may be performed by the user, however. In this case, the determination processing unit 302 can obtain information indicating the result of the comparison, input by the user. Furthermore, the determination processing unit 302 can generate difference determination data indicating a result of this determination.

The correction processing unit 303 corrects the defect data obtained by the obtainment processing unit 309. This defect data is the defect data generated by the detection processing unit 301. For example, if the defect data contains an error, the correction processing unit 303 corrects the defect data. The correction processing unit 303 may correct the defect data automatically. For example, the correction processing unit 303 can correct the defect data based on a comparison between defect data generated by a processing unit different from the detection processing unit 301 and the defect data generated by the detection processing unit 301. In the present embodiment, the user visually reviews the defect data generated by the detection processing unit 301 and manually corrects the defect data. In this case, the correction processing unit 303 can correct the defect data based on user input.

The generation processing unit 304 generates the inspection report data. The generation processing unit 304 can generate the inspection report data based on the difference determination data generated by the determination processing unit 302. The generation processing unit 304 can also generate the inspection report data based on the defect data generated by the detection processing unit 301 or corrected by the correction processing unit 303. The generation processing unit 304 may generate the inspection report data based also on the image registered by the registration processing unit 300.

A recording processing unit 306 records data. The recording processing unit 306 can record the inspection data generated during the series of processes performed to inspect the structure. The data recorded by the recording processing unit 306 includes intermediate data and final data. For example, the recording processing unit 306 can record the defect data. The recording processing unit 306 can also record the image data obtained by the registration processing unit 300, the defect data generated or corrected by the detection processing unit 301 or the correction processing unit 303, or the inspection report data generated by the generation processing unit 304. Specifically, the recording processing unit 306 can record these pieces of data in the inspection information database 204.

The recording processing unit 306 can control the series of processes for inspecting the structure based on a predetermined sequence. At this time, the recording processing unit 306 can monitor whether the data generated in each process is illegitimate data which deviates from the predetermined sequence. The recording processing unit 306 can also monitor whether the data generated in each process is reliable data.

The recording processing unit 306 can also record hash values of these pieces of data. For example, the recording processing unit 306 can record hash values of the aforementioned defect data. Such hash values can be used to verify whether the data is reliable. The hash values can be calculated by a hash value calculation unit 310 (described later). In the present specification, data being “reliable” or having “reliability” means that the data is legitimate or that the data has not been altered. In one embodiment, the recording processing unit 306 can record the hash value of a piece of data in association with that data. The recording processing unit 306 may record the hash values in the inspection information database 204.

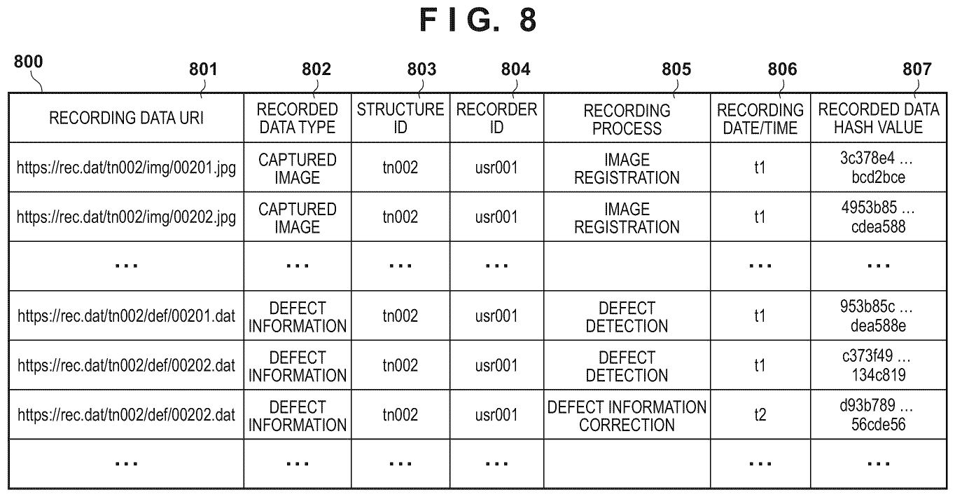

In one embodiment, the recording processing unit 306 can record the inspection processing transaction data. The transaction data indicates a history of the processing performed by the server apparatus 320 to inspect a structure. For example, the transaction data can indicate a history of the processing performed by the detection processing unit 301 to detect a defect in the structure. As will be described later with reference to FIG. 8, the transaction data can indicate hash values of the data recorded during the processing for inspecting the structure. The transaction data can also indicate the storage location of the data. For example, the transaction data can indicate the storage location of the defect data and the hash value of the defect data. The recording processing unit 306 then registers the inspection processing transaction data in the transaction database 205. The recording processing unit 306 can record the hash value of a piece of data in association with that data using such a configuration as well.

Furthermore, the recording processing unit 306 can record a hash value of the inspection processing transaction data, calculated by the hash value calculation unit 310. The recording processing unit 306 can record the hash value of the inspection processing transaction data in association with the inspection processing transaction data. The recording processing unit 306 may record the hash value in the transaction database 205.

The obtainment processing unit 309 can obtain the various types of data and the hash values thereof. For example, the obtainment processing unit 309 can obtain recorded defect data. The obtainment processing unit 309 can also obtain a recorded hash value of defect data. To that end, the obtainment processing unit 309 can search for or obtain various types of data stored in the inspection information database 204. The obtainment processing unit 309 can also search for or obtain the inspection processing transaction data stored in the transaction database 205.

The hash value calculation unit 310 calculates the hash values of data. For example, the hash value calculation unit 310 can calculate the hash value of the defect data indicating a result of detecting a defect in the structure. The hash value calculation unit 310 can calculate the hash value by inputting any desired data into a predetermined one-way hash function. This one-way hash function can provide output data of a fixed length in response to input data of any desired length. Such fixed-length output data can act as a signature unique to the input data. It is generally not possible to reproduce the original input data from a hash value obtained as the output data. The hash value calculation unit 310 can use any hash function having such characteristics. The hash value calculation unit 310 can use a secure hash algorithm that makes it possible to avoid hash value collisions. For example, the hash value calculation unit 310 can use a function according to an algorithm such as MD5, SHA1, SHA2, or SHA3 (e.g., SHA3-512). In the example described below, the hash value calculation unit 310 generates a 256-bit hash value using a hash function based on the SHA-256 secure hash algorithm.

Note that the hash value calculation unit 310 may calculate a hash value for a plurality of pieces of data. For example, the hash value calculation unit 310 may calculate a hash value for data generated from the defect data and the difference determination data. As such, in the present specification, “calculating a hash value for first data and second data” includes calculating a hash value for data generated from the first data and the second data.

A user authentication unit 308 authenticates users. For example, the user authentication unit 308 can authenticate a user as being a specific user who is permitted to perform processing. To that end, the user authentication unit 308 can hold identification information that identifies users. A combination of user ID information and a password can be given as an example of the identification information.

A verification processing unit 313 verifies whether each of types of data has been altered. The verification processing unit 313 compares the hash value calculated by the hash value calculation unit 310 for data obtained by the obtainment processing unit 309 with the hash value of the data obtained by the obtainment processing unit 309. Both of these hash values are calculated through the same method. In this manner, the verification processing unit 313 can verify whether the data obtained by the obtainment processing unit 309 has been altered. For example, the verification processing unit 313 can compare the hash value calculated by the hash value calculation unit 310 for the defect data obtained by the obtainment processing unit 309 with the hash value of the defect data obtained by the obtainment processing unit 309. In this manner, the verification processing unit 313 can verify whether the defect data obtained by the obtainment processing unit 309 has been altered. By using such a method, the verification processing unit 313 can verify whether data recorded in the past is consistent with the data obtained by the obtainment processing unit 309. The verification processing unit 313 can verify whether data registered in the inspection information database 204, the transaction database 205, or the verification record database 206 has been altered after being registered therein.

In one embodiment, the hash values are managed securely. For example, access to the transaction database 205 can be restricted. In this case, only the server apparatus 320 can correct the hash values or the inspection processing transaction data stored in the transaction database 205. The hash values or the inspection processing transaction data may also be signed using a private key held by the server apparatus 320. In another embodiment, the hash algorithm may be kept secret. Such a configuration makes it difficult to correct hash values so as to conform to altered data, which improves the reliability of the data.

The verification processing unit 313 can verify whether data used in specific processing for inspecting a structure has been altered before the specific processing is performed. In this case, the specific processing can be performed in response to the verification processing unit 313 determining that the data used in the specific processing has not been altered. In addition to the data used in the specific processing, the verification processing unit 313 may further verify whether data used to generate the data used in the specific processing (data serving as the basis of the data used in the specific processing) has been altered. In this case, the specific processing is performed in response to the verification processing unit 313 determining that these pieces of data have not been altered. This processing will be described further with reference to the flowchart in FIG. 12.

A verification recording unit 311 records a result of the verification by the verification processing unit 313. When the verification processing unit 313 performs alteration verification processing, the verification recording unit 311 can register a result of that verification in the verification record database 206 as a processing history.

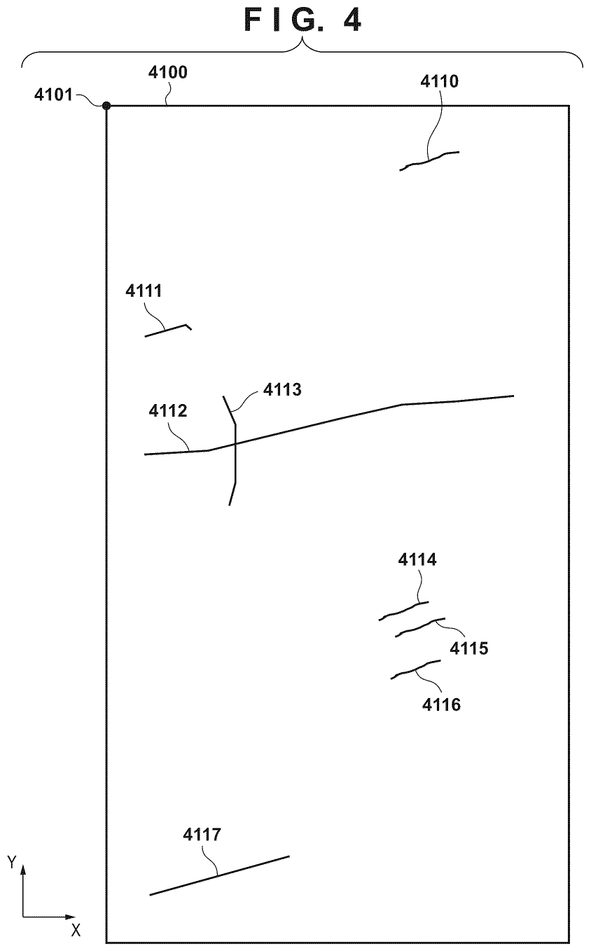

FIG. 4 illustrates an example of a defect detected from an image. In FIG. 4, polylines 4110 to 4117, which indicate crack defects, are indicated in an image 4100. In this manner, parts corresponding to crack defects can be expressed as polyline data. A “polyline” is line segment data constituted by a plurality of segments. The position of such a polyline can be defined by the coordinates of the vertices of each segment. Each polyline (or each line segment) can hold information on the width of the defect as an attribute. Each vertex constituting a polyline can be indicated by two-dimensional coordinates that take an upper-left point 4101 of the image 4100 as the origin.

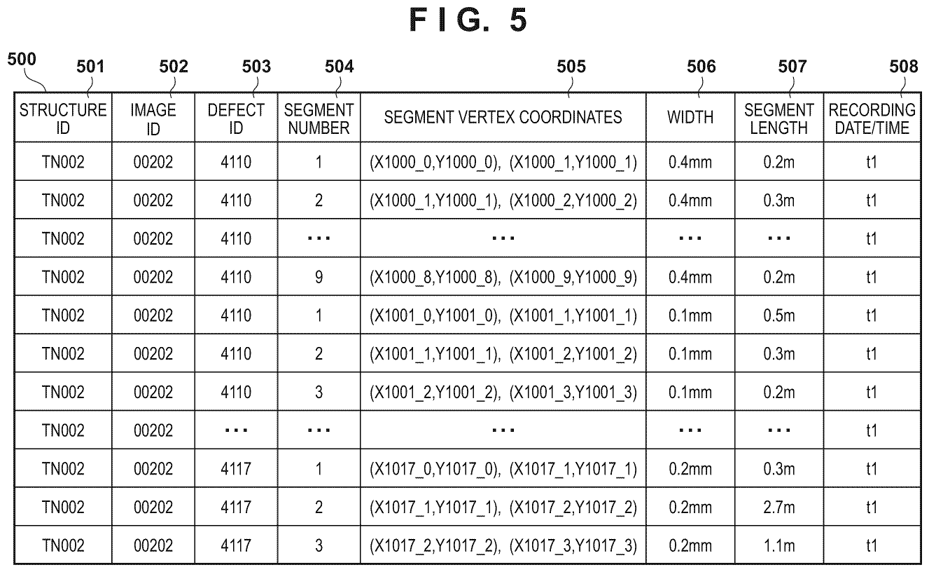

The following will describe each of pieces of data recorded in each database, with reference to FIGS. 5 to 10. In the following example, “time” can be expressed as Coordinated Universal Time (UTC) or Japan Standard Time (JST). Additionally, in the examples illustrated in FIGS. 5 to 10, the data items are stored in table format. However, each data item may be written in a structured document as extensible Markup Language (XML), JavaScript Object Notation (JSON), or the like.

FIG. 5 illustrates an example of the defect data stored in the inspection information database 204. This defect data indicates results of detecting crack defects such as those illustrated in FIG. 4. A single data item in defect data 500 includes eight pieces of information, namely Structure ID 501 to Recording Date/Time 508. Each data item can indicate information on a single defect (e.g., the position of each vertex of a polyline and the width of the polyline).

Structure ID 501 is information identifying a structure. For example, Structure ID 501 may be ID information uniquely identifying a structure to be inspected. Image ID 502 is information identifying an image of the structure. For example, Image ID 502 may be ID information identifying one of images captured of a surface of the structure indicated by Structure ID 501.

Defect ID 503 is information identifying a defect. For example, Defect ID 503 may be ID information identifying one of the defects detected from the image indicated by Image ID 502. Segment Number 504 identifies one of the segments that form the polyline corresponding to Defect ID 503. In this example, the segment numbers are integers starting from 1. Segment Vertex Coordinates 505 are the coordinates of the two endpoints of the segment indicated by Segment Number 504. The coordinates are indicated by an X-Y coordinate pair. Line Width 506 indicates an estimated width of the crack defect in the segment indicated by Segment Number 504. The width is expressed as an actual distance, in units of millimeters. Segment Length 507 is the length of the segment indicated by Segment Number 504. Segment Length 507 can indicate the length of the crack defect for that segment. The length is expressed as an actual distance, in units of meters. Note, however, that the units in the record are not particularly limited. For example, Line Width 506 and Segment Length 507 may both be recorded in identical units, e.g., in millimeters or meters. Recording Date/Time 508 indicates the time at which the data of the segment indicated by Segment Number 504 was recorded in the defect data 500.

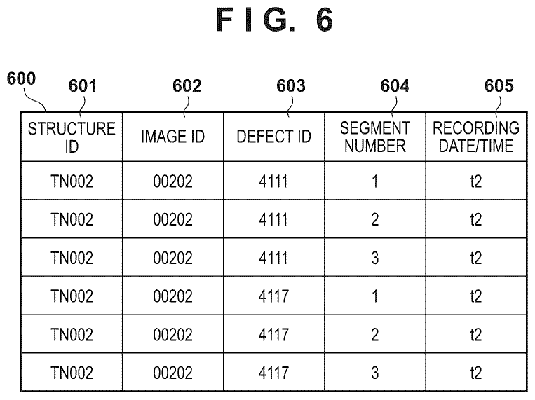

FIG. 6 illustrates an example of deleted data stored in the inspection information database 204. Deleted data 600 indicates data items, among the data items included in the defect data 500, that are subject to deletion. The correction processing unit 303 records the data items in the deleted data 600 when deleting or correcting (e.g., changing a value of) defect data. Structure ID 601, Image ID 602, Defect ID 603, and Segment Number 604 correspond to Structure ID 501, Image ID 502, Defect ID 503, and Segment Number 504, respectively, of the defect data 500, and identify data items included in the defect data 500. The data items in the defect data 500 that correspond to Structure ID 601, Image ID 602, Defect ID 603, and Segment Number 604 are treated as having been deleted. For example, when a data search request is received, the inspection information database 204 is controlled not to output the data items in the defect data 500 that correspond to Structure ID 601, Image ID 602, Defect ID 603, and Segment Number 604 recorded in the deleted data 600. Recording Date/Time 605 indicates the time when the set of Structure ID 601, Image ID 602, Defect ID 603, and Segment Number 604 were registered in the deleted data 600.

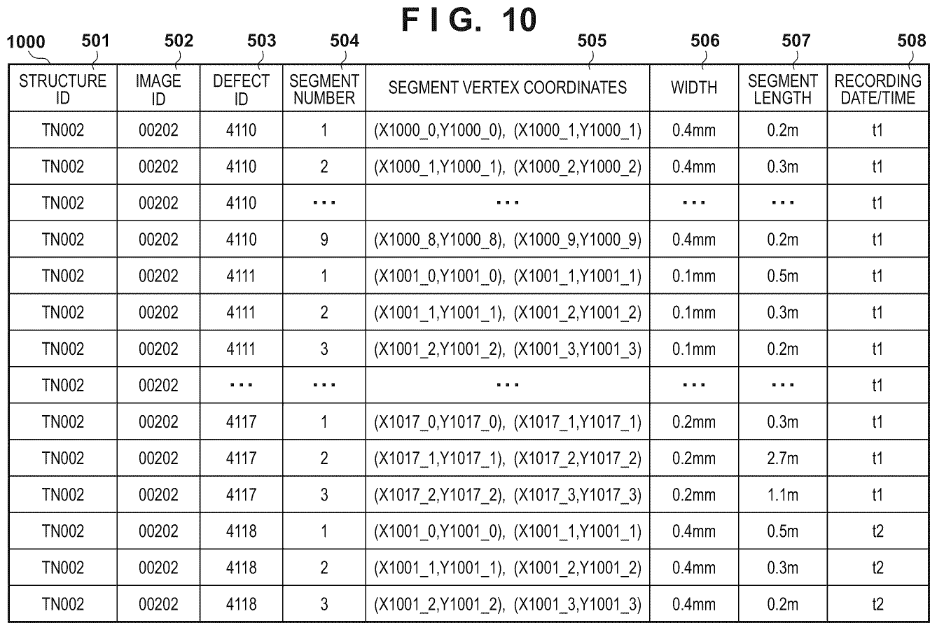

The correction of defect data will be described in further detail. FIG. 10 illustrates an example of defect data 1000 after correction processing has been performed. In this example, as a result of re-measurement, the line width of each segment corresponding to a defect ID of 4111 in the defect data 500 is corrected from 0.1 mm to 0.4 mm. As illustrated in FIG. 10, the data items corresponding to the defect ID of 4111 are not changed, but rather stay the same. However, the data items corresponding to the defect ID of 4111 are recorded in the deleted data 600 illustrated in FIG. 6. In other words, the data items corresponding to the defect ID of 4111 are treated as having been deleted. Furthermore, data items corresponding to a defect ID of 4118 have been newly added to the defect data 1000. The data items corresponding to the defect ID of 4118 have been obtained by changing the line width to 0.4 mm in the data items corresponding to the defect ID of 4111. In this manner, in the present embodiment, instead of deleting data items in the defect data 500, the recording processing unit 306 registers those data items in the deleted data 600 as being subject to deletion, and adds the corrected data items to the defect data 1000. With such a configuration, the details of correction processing performed on the defect data can be verified later.

A case where data items corresponding to a defect ID of 4117 indicated in the defect data 500 are deleted will be described next. The user can instruct these data items to be deleted, for example. In this case, the recording processing unit 306 records the data items corresponding to the defect ID of 4117 in the deleted data 600. However, the data items corresponding to the defect ID of 4117 remain in the defect data 1000 after the deletion processing. The combination of the deleted data 600 and the defect data 1000 indicates that the data items corresponding to the defect ID of 4117 have been deleted. With such a configuration, the details of deletion processing performed on the defect data can be verified later.

Note that a history of the correction processing and the deletion processing is recorded in the transaction database 205 as the inspection processing transaction data. The inspection processing transaction data will be described later with reference to FIG. 8.

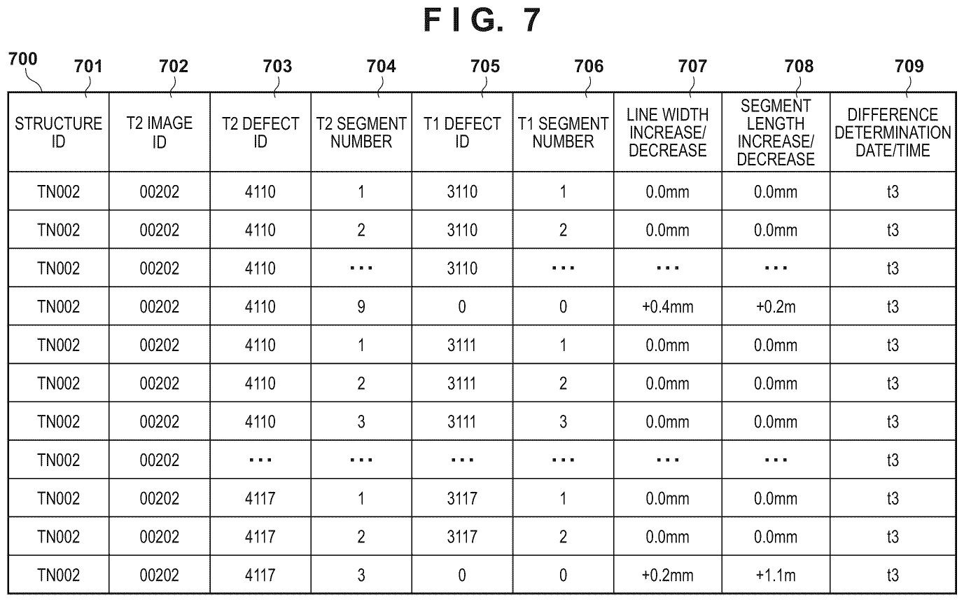

FIG. 7 illustrates an example of difference determination data stored in the inspection information database 204. As described above, difference determination data 700 is generated by the determination processing unit 302. In the following example, the determination processing unit 302 compares defects detected from each of images captured at different times. However, the subjects of the comparison are not particularly limited. For example, the determination processing unit 302 may compare defects detected from the same captured image using different detection methods.

Like Structure ID 501, Structure ID 701 is information identifying a structure. T2 Image ID 702 is information identifying one of the images subject to the comparison. For example, T2 Image ID 702 can indicate the image, in the set of the images subject to the comparison, that was captured at a later time. T2 Defect ID 703 is information identifying one defect in a set of defects subject to the comparison. For example, T2 Defect ID 703 identifies one of the defects detected from the captured image indicated by T2 Image ID 702. T2 Segment Number 704 is information identifying one of the segments subject to the comparison. For example, T2 Segment Number 704 identifies one of the segments in the defect (polyline) indicated by T2 Defect ID 703.

T1 Defect ID 705 is information identifying the other defect in a set of defects subject to the comparison. T1 Segment Number 706 is information identifying one of the segments subject to the comparison. For example, T1 Segment Number 706 identifies one of the segments in the defect (polyline) indicated by T1 Defect ID 705.

Line Width Increase/Decrease 707 indicates a result of comparing the line width of the crack defect indicated by T2 Segment Number 704 with the line width of the crack defect indicated by T1 Segment Number 706. In this example, Line Width Increase/Decrease 707 indicates the increase or decrease in the line width as an actual width, in units of millimeters. “0.0 mm” indicates no increase or decrease. “+0.4 mm” indicates that the line width of the crack defect indicated by T2 Segment Number 704 is 0.4 mm larger than the line width of the crack defect indicated by T1 Segment Number 706. When comparing defect data over time, the width of the defect does not usually decrease. However, there are some instances where the width decreases (i.e., shifts to a negative value), due to differences in measurement precision, error, restoration work, or the like.

Segment Length Increase/Decrease 708 indicates a result of comparing the length of the crack defect indicated by T2 Segment Number 704 with the length of the crack defect indicated by T1 Segment Number 706. In this example, Segment Length Increase/Decrease 708 indicates an increase or decrease in the length of the segment, in units of meters. “0.0 m” indicates no increase or decrease. “+0.2 m” indicates that the segment length of the crack defect indicated by T2 Segment Number 704 is 0.2 m longer than the segment length of the crack defect indicated by T1 Segment Number 706. This value is negative when the segment length has decreased.

Difference Determination Date/Time 709 indicates the time at which the set of the items from Structure ID 701 to Segment Length Increase/Decrease 708 were recorded in the difference determination data 700.

FIG. 8 illustrates an example of the inspection processing transaction data stored in the transaction database 205. Inspection processing transaction data 800 indicates a history of the execution of the series of processes in the inspection of a structure. The inspection processing transaction data 800 records, as metadata, information related to the generation or distribution of data in the stated series of processes.

Recorded Data URI 801 identifies the individual pieces of recorded data recorded in the inspection information database 204. In this example, the recorded data includes the defect data 500. The recorded data can also include the deleted data 600. Furthermore, the recorded data can include at least one of the difference determination data 700, the image data registered by the registration processing unit 300, and the inspection report data generated by the generation processing unit 304. Recorded Data URI 801 can indicate the locations of these pieces of data. In the present embodiment, Recorded Data URI 801 is in URL format, and each piece of data can be obtained using the HTTPS protocol. However, Recorded Data URI 801 can be any desired information that enables the data to be identified and obtained.

Recorded Data Type 802 indicates the type of the data indicated by Recorded Data URI 801. In the present embodiment, “captured image”, “defect data”, “deleted data”, “difference determination data”, or “inspection report” is registered as the type of the recorded data. However, “composite image”, which indicates a result of compositing a plurality of images, “modified image”, which indicates a result of image modification processing suited to the detection of defects, or the like may be set as types of the recorded data, depending on the process.

Like Structure ID 501, Structure ID 803 is information identifying a structure to be inspected. Recorder ID 804 is information identifying the user who performed the processing for recording the data indicated by Recorded Data URI 801. Recording Process 805 is information identifying the process during which the data was recorded. Recording Process 805 can indicate one of predefined processes performed in the inspection processing. In the present embodiment, “image registration”, “defect detection”, “defect information correction”, “defect difference determination”, or “inspection report generation” is recorded as Recording Process 805. However, if there is another process involving the recording of data as a predefined process, that other process is also recorded as Recording Process 805. Recording Date/Time 806 indicates the time at which the data indicated by Recorded Data URI 801 was recorded.

Recorded Data Hash Value 807 indicates the hash value of the recorded data indicated by Recorded Data URI 801. As described above, the hash value calculation unit 310 can calculate the hash values of the recorded data. Note that the recorded data for which Recorded Data Type 802 is “defect information”, i.e., the defect data, is corrected in a defect information correction process. A data item is added to the inspection processing transaction data 800 each time the defect data is corrected. As such, a plurality of data items corresponding to the same Recorded Data URI 801 are added to the inspection processing transaction data 800 as additional processes are performed. In this case, a plurality of different Recorded Data Hash Values 807 corresponding to the same Recorded Data URI 801 are recorded. In such a case, the newest Recorded Data Hash Value 807 can be obtained by searching for the data item that corresponds to Recorded Data URI 801 and that has the newest Recording Date/Time 806.

For example, the defect data 500 (00202.dat) has been recorded in the inspection processing transaction data 800 as a result of the defect detection processing performed by the detection processing unit 301. Thereafter, the correction processing unit 303 corrects the defect data 500 to the defect data 1000 through the correction processing. At this time, the record URI does not change, but the defect data 00202.dat indicated by the record URI is changed. A data item including the recorded data hash value and a recording date/time t2 for the changed defect data, indicated by the recorded data URI, are additionally recorded in the inspection processing transaction data 800. The recorded data hash value corresponding to the newest recording date/time is used when verifying alterations.

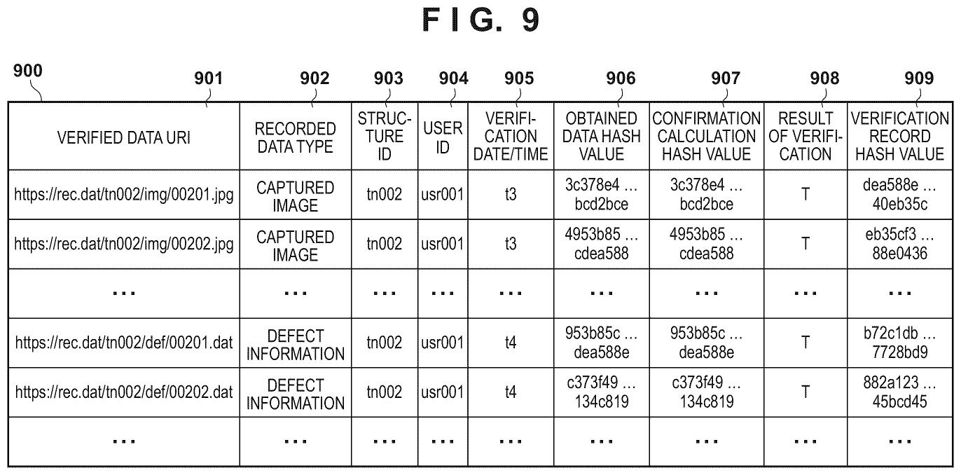

FIG. 9 illustrates an example of the alteration verification record data stored in the verification record database 206. When the verification processing unit 313 verifies the consistency of the data, the verification recording unit 311 can add a data item indicating the result of the verification to alteration verification record data 900. For example, when obtaining data from the inspection information database 204 or the transaction database 205, the verification processing unit 313 can verify whether the obtained data has been altered. The verification recording unit 311 can record a history of the verification in the verification record database 206 at this time.

Verified Data URI 901 is information, similar to Recorded Data URI 801, for identifying the recorded data subject to the verification processing. The recorded data subject to the verification processing is, for example, the defect data 500 recorded in the inspection information database 204. The recorded data subject to the verification processing can include at least one of the deleted data 600, the difference determination data 700, the image data, and the inspection report data recorded in the inspection information database 204. Furthermore, the recorded data subject to the verification processing can include the inspection processing transaction data 800 recorded in the transaction database 205.

Like Recorded Data Type 802, Recorded Data Type 902 indicates the type of the data indicated by Verified Data URI 901. In this example, the recorded data type of the inspection processing transaction data 800 is “transaction”. Like Structure ID 501, Structure ID 903 is information identifying a structure to be inspected. User ID 904 is information identifying the user who performed the processing for obtaining the data indicated by Verified Data URI 901. User ID 904 can indicate the user who directly performed an operation for obtaining the data. However, there are situations where the detection processing unit 301, the determination processing unit 302, the correction processing unit 303, the generation processing unit 304, or the recording processing unit 306 perform processing based on a user instruction, and that processing involves processing for obtaining data. In such a case, where the data is obtained in processing performed based on a user instruction, User ID 904 can indicate the user who made the user instruction.

Verification Date/Time 905 indicates the time at which the verification processing was performed on the recorded data. Obtained Data Hash Value 906 indicates the Recorded Data Hash Values 807 obtained from the inspection processing transaction data 800 by the verification processing unit 313 for the verification processing. Confirmation Calculation Hash Value 907 indicates the hash value of the recorded data calculated by the hash value calculation unit 310 for the verification processing. As described above, the hash value calculation unit 310 calculates the hash value of the data indicated by Verified Data URI 901 through the same method as that used to calculate Recorded Data Hash Value 807. If Obtained Data Hash Value 906 and Confirmation Calculation Hash Value 907 are the same, the verification processing unit 313 determines that the data indicated by Verified Data URI 901 has not changed since being recorded. The verification recording unit 311 then records “T”, indicating “TRUE”, in Verification Result 908. On the other hand, if Obtained Data Hash Value 906 and Confirmation Calculation Hash Value 907 are different, the verification processing unit 313 determines that the data indicated by Verified Data URI 901 has been altered in some way. The verification recording unit 311 then records “F”, indicating “FALSE”, in Verification Result 908.

The hash value calculation unit 310 can further calculate a hash value for the data indicating the verification result. In the example in FIG. 9, the hash value calculation unit 310 calculates a hash value of concatenated data obtained by concatenating binary data of the values of Verified Data URI 901 to Verification Result 908. The verification recording unit 311 then records the calculated hash value as Verification Record Hash Value 909. This makes it possible to prevent alterations to the data items themselves recorded in the alteration verification record data 900.

FIG. 12 is a flowchart of processing performed by the inspection processing system according to one embodiment. In the present embodiment, the server apparatus 320 detects a defect in a structure based on an image of the structure. The server apparatus 320 then compares the defect data indicating a result of the defect detection with past defect data stored for the structure. The server apparatus 320 then generates an inspection report based on the result of the defect detection. FIGS. 11A to 11M illustrate an example of a user interface in the inspection app 200, which runs on a client apparatus and is used to cause the server apparatus 320 to perform such processing. The processing performed in the present embodiment will be described hereinafter with reference to FIGS. 11A to 11M. Note that the processing may be suspended partway through the flowchart illustrated in FIG. 12. The processing may also be started from partway through the flowchart illustrated in FIG. 12. In this case, the processing can be started from one of the instances of alteration verification processing (steps S1205, S1207, S1209, S1211, S1213, S1215, and S1217).

In step S1201, the user enters login information. In this example, the inspection app 200 is launched in the client apparatus in response to an instruction from the operation input unit 106. FIG. 11A illustrates an example of a login screen displayed in the inspection app. A username is entered in a text box 1101 as user account information. In the example in FIG. 11A, a username “usr001” is entered in the text box 1101. A pre-registered password corresponding to the username is entered in a text box 1102. In the example in FIG. 11A, the entered password is hidden, and is therefore displayed as asterisks. The entered password may be displayed, however. The user presses a login instruction button 1103 after entering the username and the password. The sequence moves to step S1202 once the login instruction button 1103 is pressed. However, if a cancel/terminate button 1104 is pressed, the sequence moves to step S1220. The operations performed when the cancel/terminate button 1104 is pressed are the same for the other steps as well.

In step S1202, the inspection app 200 sends the entered username and password to the user authentication unit 308 of the server apparatus 320. The user authentication unit 308 then performs user authentication and login processing. For example, the user authentication unit 308 authenticates the user by verifying the username and password that were sent against user ID information and passwords that are stored. The user authentication unit 308 then sends the result of the user authentication to the inspection app 200. If the user authentication is successful, the user authentication unit 308 performs the login processing for the user. For example, the user authentication unit 308 can hold the username of the logged-in user. The sequence then moves to step S1203. However, if the user authentication fails, the inspection app 200 clears the values entered in the text boxes 1101 and 1102. The inspection app 200 then requests the username and password to be entered again.

In step S1203, a structure to be inspected is designated. FIG. 11B illustrates an example of an inspection target selection screen. A window 1100 of the inspection app includes a display region 1110. Predefined inspection processes are displayed in the display region 1110. The current process is indicated by a white rectangle having a black frame 1117. Processes which have ended or which have not yet been performed are indicated by hatched rectangles. The black downward-pointing triangles indicate the order of the processes.

Structures for which inspection data is already registered are displayed in an inspection target data list 1122. A structure to be inspected can be designated from among the displayed structures. In the example in FIG. 11B, inspection data has already been registered for three structures. A “new” item 1123 is selected when starting the inspection processing for a new structure. The operation for making the selection is performed using the operation input unit 106. The selected item is displayed in an inverted manner. FIG. 11B illustrates a state in which the “new” item is selected.

When a structure is selected, information on the selected structure is displayed in a structure name 1124 and a structure type 1125. When “new” item is selected, the user enters the structure name 1124 and the structure type 1125. In FIG. 11B, the user has entered “XYZ road DDD tunnel” as the structure name and “tunnel” as the structure type. When an “OK” button 1126 is pressed, the inspection app 200 sends the information on the designated structure to the server apparatus 320. The inspection app 200 can send the information on the structure name and the structure type, entered by the user, to the server apparatus 320. The registration processing unit 300 stores the sent information in the inspection information database 204. Additionally, if a structure is selected, the inspection app 200 can send information identifying the structure designated by the user to the server apparatus 320. The sequence then moves to step S1204.

In step S1204, a captured image is registered. Here, a captured image of the structure is registered as the inspection data of the structure designated in step S1203. The inspection app 200 displays an operation screen for the “image registration” process. FIG. 11C illustrates an example of the image registration screen. In this example, the image data of captured images is stored in a location that can be accessed from the client apparatus and the server apparatus 320. The user enters a path indicating the storage location of the captured image in an image storage path 1131. Once the path is entered, the image data stored in the location indicated by the path is displayed in a display region 1132. Using the operation input unit 106, the user can select captured images to be registered from among the captured images displayed in the display region 1132. In FIG. 11C, the selected images are emphasized by black frames. This makes it possible to identify selected images and unselected images.

Once the images to be registered have been selected, the user presses the “OK” button 1126. The inspection app 200 then sends path information indicating the storage location of the image data to the server apparatus 320. The registration processing unit 300 controls the recording processing unit 306 to register the image data of the selected captured images. For example, the recording processing unit 306 can store the image data in the storage server 202. However, the recording processing unit 306 may register the path information of the image data in the inspection information database 204. Doing so eliminates the need to store the image data in the storage server 202. Additionally, the hash value calculation unit 310 calculates a hash value of the registered image data when the data is recorded in the recording processing unit 306.

Furthermore, the recording processing unit 306 records the hash value of the image data calculated by the hash value calculation unit 310. In the present embodiment, the recording processing unit 306 registers information indicating a history of the image registration processes in the transaction database 205. For example, the recording processing unit 306 can add a data item to the inspection processing transaction data 800. The data item includes the following information. Recorded Data URI 801 indicates the path information of the registered image data. Recorded Data Type 802 is “captured image”. Structure ID is an ID issued for the structure to be inspected. Recorder ID 804 is the user ID of the logged-in user, held by the user authentication unit 308. Recording Process 805 is “image registration”. Recording Date/Time 806 is the time when the image was registered. Recorded Data Hash Value 807 is the hash value calculated by the hash value calculation unit 310 for the registered image data.

Furthermore, the inspection app 200 notifies the user when the image registration ends. FIG. 11D illustrates an example of the window 1100 of the inspection app 200 displayed at this time. In this example, the hash value of the recorded data being recorded in the inspection processing transaction data 800 makes it possible to verify whether the data has been altered. A message 1112 indicating the integrity of the recorded data is therefore displayed in the window 1100. When the “OK” button 1126 is pressed, the sequence moves to step S1205.

In step S1205, the verification processing unit 313 verifies whether the image data used in the defect detection process, which is the next process, has been altered. Prior to the defect detection process, the verification processing unit 313 can verify whether the recorded image data has been altered after being recorded. Normally, it is unlikely that image data has been altered immediately after that image data was newly registered. However, if an extended period of time has passed from the process for registering the image data to the defect detection process, it is possible that the image has been intentionally altered to prevent defects from being detected or cause defects to be detected excessively. Accordingly, the verification processing unit 313 verifies whether the image data has been altered.

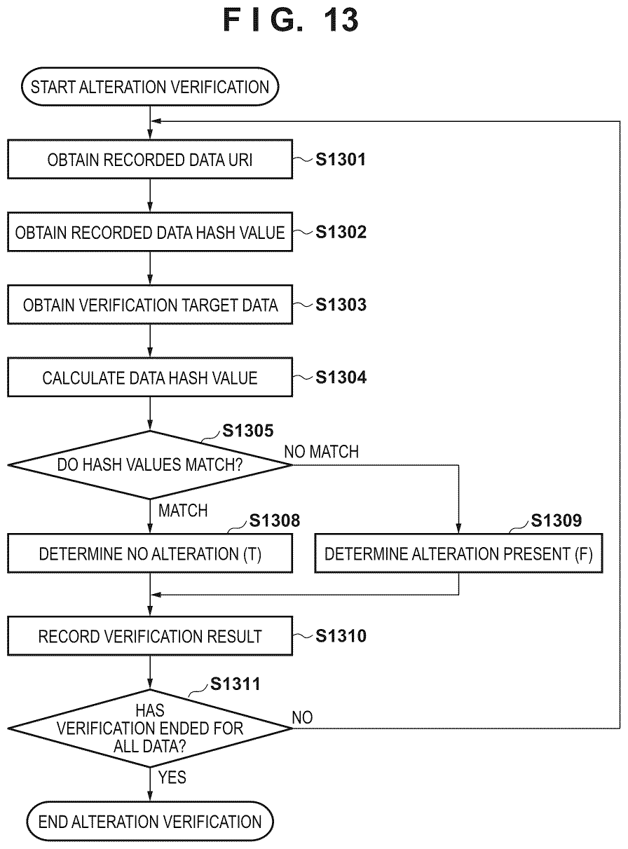

The alteration verification process will be described in detail later with reference to FIG. 13. To describe the process briefly, the obtainment processing unit 309 obtains the registered image data and the hash value of the recorded image data. The verification processing unit 313 then compares the hash value calculated by the hash value calculation unit 310 for the image data obtained by the obtainment processing unit 309 with the hash value of the image data obtained by the obtainment processing unit 309. In this manner, the verification processing unit 313 verifies whether the image data obtained by the obtainment processing unit 309 has been altered. The verification processing unit 313 communicates the result of the verification to the inspection app 200. If the data is determined not to have been altered (T), the sequence moves to step S1206. However, if the data is determined to have been altered (F), the sequence moves to step S1219.

In step S1206, the detection processing unit 301 performs the defect detection process based on the registered image data. The detection processing unit 301 can generate the defect data 500 indicating the result of the detection, as described above. The recording processing unit 306 registers the defect data 500 generated in this manner in the inspection information database 204. The recording processing unit 306 also records a history of the defect detection processes in the inspection processing transaction data 800. As described above, the recording processing unit 306 can record Recorded Data URI 801 for the defect data 500, Recorded Data Hash Value 807 for the defect data 500, and the like in the inspection processing transaction data 800. The sequence then moves to step S1207.

In step S1207, the verification processing unit 313 verifies whether the defect data used in a defect detection result review process, which is the next process, has been altered, before that process is performed. The verification processing unit 313 can also verify whether the image data serving as the basis of the defect data has been altered. Note that the image data serving as the basis of the defect data can be identified by Image ID 602. The alteration verification process will be described in detail later with reference to FIG. 13. The verification processing unit 313 communicates the result of the verification to the inspection app 200. If the data is determined not to have been altered (T), the sequence moves to step S1208. However, if the data is determined to have been altered (F), the sequence moves to step S1219.

In step S1208, the result of the defect detection from the defect data is displayed. FIG. 11E illustrates an example of a defect detection result review screen displayed in the window 1100 of the inspection app 200. As a result of the alteration verification performed in step S1207, the displayed defect data and the captured image serving as the basis of the defect data are confirmed as not having been altered. The message 1112 indicating the integrity of the recorded data is therefore displayed. Note that the defect data obtained in step S1206 can be displayed for each captured image.

In the example in FIG. 11E, the processing has continued from the inspection target selection process of step S1203 without the inspection app 200 being terminated even once. Accordingly, a structure to be displayed 1144 is the same as the selected structure to be inspected. The user can select one piece of image data related to the defect data to be displayed, from among the image data displayed in a defect information selection list region 1141. The selected image data is emphasized by a black frame. When the user presses a “VIEW” button 1142, the window 1100 transitions to the display state illustrated in FIG. 11F.

FIG. 11F illustrates an example of the display format of the designated defect data. In this example, the defect data detected based on the image data selected in the defect information selection list region 1141 is displayed. A display region 1151 includes a reduced display of the image, such that the entire selected image can be seen. Furthermore, an object indicating the detected defect is superimposed on the reduced display of the image. A rectangular frame indicating a range displayed in a defect information enlarged display region 1152 is also superimposed on the reduced display of the image. The defect information enlarged display region 1152 includes an enlarged display of the selected image such that part of the defect information can be observed closely. An object indicating the detected defect is also superimposed on the enlarged display of the image. The user can designate a single defect by manipulating a pointer 1153. Attribute data of the designated defect is displayed in an attribute data display region 1154. The attribute data of the defect is, for example, the values of the line width and the segment length, and is included in the defect data 500. Additionally, as described with reference to FIG. 11E, the image data to be displayed can be switched. After the defect detection result has been reviewed, the user presses a “FINISH” button 1143. The sequence then moves to step S1209.

In step S1209, the verification processing unit 313 verifies whether the defect data used in the defect information correction process, which is the next process, has been altered, before that process is performed. The verification processing unit 313 can also verify whether the image data serving as the basis of the defect data has been altered. Normally, it is unlikely that this data has been altered immediately after the result of the defect detection is reviewed. However, if an extended period of time has passed from the process for reviewing the result to the defect information correction process, it is possible that the data has been altered. Accordingly, the verification processing unit 313 verifies whether the data has been altered. The alteration verification process will be described in detail later with reference to FIG. 13. The verification processing unit 313 communicates the result of the verification to the inspection app 200. If the data is determined not to have been altered (T), the sequence moves to step S1210. However, if the data is determined to have been altered (F), the sequence moves to step S1219.

In step S1210, the correction processing unit 303 corrects the defect data. FIG. 11G illustrates an example of a defect information correction screen displayed in the window 1100 of the inspection app 200. As a result of the alteration verification performed in step S1209, the displayed defect data and the captured image serving as the basis of the defect data are confirmed as not having been altered. The message 1112 indicating the integrity of the recorded data is therefore displayed. The user selects the image data related to the defect data to be corrected by performing the operations described with reference to FIG. 11E. The window 1100 then transits to the display state illustrated in FIG. 11H.

FIG. 11H is an example of the display format of the selected defect data to be corrected. Elements that are the same as those in FIG. 11F are given the same reference signs. The user can designate a defect to be corrected by manipulating the pointer 1153. Then, when a “DEL” button 1156 is pressed while the defect is designated by the pointer 1153, the information of the designated defect is deleted. In this example, the window 1100 transits to the display state illustrated in FIG. 11I. Here, the designated defect is deleted from the defect information enlarged display region 1152. At this time, as described above, the correction processing unit 303 controls the recording processing unit 306 to record the deletion of the defect. The recording processing unit 306 then records the defect ID of the defect to be deleted in the deleted data 600.

While the defect is designated using the pointer 1153, the user can also correct the attribute data of that designated defect. In this case, the user can correct values such as the line width, the segment length, or the like displayed in the attribute data display region 1154. When the attribute data is corrected in this manner, the correction processing unit 303 controls the recording processing unit 306 to record the correction for that defect, as described above. The recording processing unit 306 then records the defect ID of the corrected defect in the deleted data 600. The recording processing unit 306 further records the attribute data of the corrected defect in the defect data 500 with a new defect ID.

When the user presses an add button “ADD” 1155 while a desired position in the defect information enlarged display region 1152 is designated with the pointer 1153, a defect is added at the designated position. The user may enter attribute data for the added defect in the attribute data display region 1154. When a defect is added in this manner, the correction processing unit 303 controls the recording processing unit 306 to record the addition of the defect, as described above. The recording processing unit 306 then records the information on the new defect in the defect data 500 with a new defect ID.

After the defect data has been corrected, the user presses the “FINISH” button 1143. As described above, when the defect data is corrected, the recording processing unit 306 records the corrected defect data. Furthermore, the recording processing unit 306 records the hash value of the corrected defect data, calculated by the hash value calculation unit 310. In the present embodiment, the recording processing unit 306 records a history of the defect information correction processes in the transaction database 205. As described above, the recording processing unit 306 can record Recorded Data URI 801 for the corrected defect data 1000, Recorded Data Hash Value 807 for the corrected defect data 1000, and the like in the inspection processing transaction data 800. The recording processing unit 306 can also record Recorded Data URI 801 of the deleted data 600, Recorded Data Hash Value 807 for the deleted data 600, and the like in the inspection processing transaction data 800. The sequence then moves to step S1211. Note that even if the cancel/terminate button 1104 is pressed, the recording processing unit 306 can still record the history of the defect information correction processes in the transaction database 205 as long as the defect data has been corrected before the button was pressed.

In step S1211, the verification processing unit 313 verifies whether the defect data used in a defect difference determination process, which is the next process, has been altered, before that process is performed. The verification processing unit 313 can also verify whether the image data serving as the basis of the defect data has been altered. Normally, it is unlikely that this data has been altered immediately after the result of the defect detection is corrected. However, if an extended period of time has passed from the process for correcting the result to the defect difference determination process, it is possible that the data has been altered. Accordingly, the verification processing unit 313 verifies whether the data has been altered. The alteration verification process will be described in detail later with reference to FIG. 13. To describe the process briefly, the obtainment processing unit 309 first obtains the recorded defect data (or corrected defect data) and the hash value of the recorded defect data (or of the corrected defect data). Then, the verification processing unit 313 compares the hash value of the defect data (or the corrected defect data) obtained by the obtainment processing unit 309, calculated by the hash value calculation unit 310, with the hash value of the defect data (or the corrected defect data) obtained by the obtainment processing unit 309. In this manner, the verification processing unit 313 verifies whether the defect data (or the corrected defect data) obtained by the obtainment processing unit 309 has been altered. The verification processing unit 313 communicates the result of the verification to the inspection app 200. If the data is determined not to have been altered (T), the sequence moves to step S1212. However, if the data is determined to have been altered (F), the sequence moves to step S1219.

In step S1212, the determination processing unit 302 compares the defect data generated this time with defect data generated previously, as described above. In this manner, the determination processing unit 302 can detect differences in and classify the defect. Note that if the current inspection is the first inspection of the structure to be inspected and there is no past defect data, the determination processing unit 302 can determine that there is no difference in the defect. The determination processing unit 302 may determine whether the width has changed or the segment length has changed for each segment of the polyline indicating the defect. The determination processing unit 302 then controls the recording processing unit 306 to record the result of the determination. The recording processing unit 306 can record the result of the determination in the difference determination data 700. The recording processing unit 306 can also record a history of the determination processes in the inspection processing transaction data 800. The sequence then moves to step S1230.

In step S1213, the verification processing unit 313 verifies whether the defect data and the difference determination data used in a defect difference review process, which is the next process, has been altered, before that process is performed. The verification processing unit 313 can verify whether the image data serving as the basis of these pieces of data has been altered. Note that the image data that serves as the basis of the difference determination data can be identified by T2 Image ID 702, T1 Defect ID 705, Defect ID 503, and Image ID 502. Normally, it is unlikely that this data has been altered immediately after the defect difference determination is made. However, if an extended period of time has passed from the defect difference determination process to the defect difference review process, it is possible that the data has been altered. Accordingly, the verification processing unit 313 verifies whether the data has been altered. The alteration verification process will be described in detail later with reference to FIG. 13. The verification processing unit 313 communicates the result of the verification to the inspection app 200. If the data is determined not to have been altered (T), the sequence moves to step S1214. However, if the data is determined to have been altered (F), the sequence moves to step S1219.

In step S1214, a defect difference determination result according to the difference determination data is displayed. FIG. 11J illustrates an example of a defect difference review screen displayed in the window 1100 of the inspection app 200. As a result of the alteration verification performed in step S1213, the displayed difference determination data and defect data, as well as and the captured images serving as the bases of those pieces of data, are confirmed as not having been altered. The message 1112 indicating the integrity of the recorded data is therefore displayed.

In this example, like the defect detection result review process, the defect difference determination result is reviewed for each captured image subject to defect detection. As described with reference to FIG. 11E, the user can select one piece of image data related to the defect difference determination result to be reviewed, from among the image data displayed in the defect information selection list region 1141. When the user presses the “VIEW” button 1142, the window 1100 transitions to the display state illustrated in FIG. 11K.

FIG. 11K illustrates an example of the display format of the designated defect difference determination result. Elements that are the same as in the defect detection result review screen illustrated in FIG. 11F are given the same reference signs. In the defect information enlarged display region 1152, the segment where a difference has occurred is displayed with emphasis using a bold black line. In this manner, segments in which a difference is determined to have occurred are displayed so as to be distinguishable from segments in which a difference is determined not to have occurred, which are indicated by thin lines. The differences in the attribute data of the designated defect are indicated in the attribute data display region 1154. For example, an amount of change in the line width and an amount of change in the segment length, which are indicated by the difference determination data 700, are displayed as ΔW and ΔL, respectively, in the attribute data display region 1154. After the defect difference determination result has been reviewed, the user presses the “FINISH” button 1143. The sequence then moves to step S1215.

In step S1215, the verification processing unit 313 verifies whether the defect data and the difference determination data used in an inspection report generation process, which is the next process, has been altered, before that process is performed. The verification processing unit 313 also verifies whether the image data serving as the basis of these pieces of data has been altered. To be more specific, the verification processing unit 313 determines whether the difference determination data obtained by the obtainment processing unit 309, the plurality of pieces of defect data used to generate the difference determination data, and the data of the plurality of images used to generate the plurality of pieces of defect data have been altered. Then, in step S1216, the generation processing unit 304 generates the inspection report data in response to the verification processing unit 313 determining that those pieces of data have not been altered. Normally, it is unlikely that this data has been altered immediately after the result of the defect difference determination is reviewed. However, if an extended period of time has passed from the defect difference review process to the inspection report generation process, it is possible that the data has been altered. Accordingly, the verification processing unit 313 verifies whether the data has been altered.

The alteration verification process will be described in detail later with reference to FIG. 13. To describe the process briefly, the obtainment processing unit 309 obtains the recorded difference determination data and the hash value of the recorded difference determination data. The verification processing unit 313 then compares the hash value calculated by the hash value calculation unit 310 for the difference determination data obtained by the obtainment processing unit 309 with the hash value of the difference determination data obtained by the obtainment processing unit 309. In this manner, the verification processing unit 313 verifies whether the difference determination data obtained by the obtainment processing unit 309 has been altered. Whether the defect data and the image data have been altered can be verified in the same manner. The verification processing unit 313 communicates the result of the verification to the inspection app 200. If the data is determined not to have been altered (T), the sequence moves to step S1216. However, if the data is determined to have been altered (F), the sequence moves to step S1219.

In step S1216, the generation processing unit 304 generates inspection report data for the current inspection based on the defect difference determination data. The inspection report data is one piece of data corresponding to the structure to be inspected. The inspection report data can include the structure name, a report date, an inspector name, the year/month of the previous inspection, and the year/month of the current inspection as bibliographic matters. The structure name is entered or designated in step S1203. The report date is the date on which the process for generating the inspection report data ended. The inspector name is the actual username corresponding to the logged-in user. This actual username may be recorded in the user authentication unit 308 in advance. For example, an actual username of “last name, first name”, corresponding to the username “usr001” of the logged-in user, may be recorded. The year/month of the previous inspection and the year/month of the current inspection are the year/month when the captured image corresponding to defect data generated previously was captured, and the year/month when the captured image corresponding to the defect data generated this time was captured, respectively. The defect data generated previously and the defect data generated this time indicate the data used in the difference determination process performed in step S1212.

The inspection report data can include, as an inspection report summary, information on a total number of units to be inspected, a total number of determinations that repairs are necessary, and the units to be inspected for which it has been determined that repairs are necessary. The generation processing unit 304 can determine whether repairs are necessary based on statistical values of the changes in the line width and the changes in the segment length, indicated by the difference determination data 700. The “unit to be inspected” is defined for each structure to be inspected. For example, if the structure is a tunnel, the unit to be inspected may be a “span”, which is a unit of lining. The generation processing unit 304 can determine whether it is necessary to repair each inspection target based on changes in the line width and changes in the segment length of the defect detected from the inspection target. The total number of determinations that repairs are necessary indicates the total number of units to be inspected, for which it has been determined that repairs are necessary. The information on the units to be inspected can also include a number identifying the unit to be inspected (e.g., a span number) for which it is has been determined that repairs are necessary. Furthermore, the information on the unit to be inspected can include information pertaining to changes in defects. For example, the information on the unit to be inspected can include the amount by which the length of the crack has increased, or the percentage of cracks whose widths have increased. The information on the unit to be inspected may further include information used for referring to image data, defect data, and difference determination data related to the unit to be inspected (e.g., access path information or a URI) as attribute information.

The generation processing unit 304 then controls the recording processing unit 306 to record the generated inspection report data. The recording processing unit 306 can record the inspection report data in a storage location that can be accessed. The recording processing unit 306 can then record Recorded Data URI 801 for the inspection report data, Recorded Data Hash Value 807 for the inspection report data, and the like in the inspection processing transaction data 800. The sequence then moves to step S1217.

In step S1217, the verification processing unit 313 verifies whether the inspection report data used in an inspection report review process, which is the next process, has been altered, before that process is performed. The verification processing unit 313 can also verify whether the image data, defect data, and difference determination data serving as the basis of the inspection report data has been altered. To that end, the inspection report data may include information identifying the image data, defect data, and difference determination data serving as the basis of the inspection report data. Normally, it is unlikely that this data has been altered immediately after the inspection report is generated. However, if an extended period of time has passed from the inspection report generation process to the inspection report review process, it is possible that the data has been altered. Accordingly, the verification processing unit 313 verifies whether the data has been altered. The alteration verification process will be described in detail later with reference to FIG. 13. The verification processing unit 313 communicates the result of the verification to the inspection app 200. If the data is determined not to have been altered (T), the sequence moves to step S1218. However, if the data is determined to have been altered (F), the sequence moves to step S1219.

In step S1218, the inspection report according to the inspection report data is displayed. FIG. 11L illustrates an example of an inspection report review screen displayed in the window 1100 of the inspection app 200. As a result of the alteration verification performed in step S1217, the displayed inspection report data, as well as and the image data, the defect data, and the difference determination data serving as the basis thereof, are confirmed as not having been altered. The message 1112 indicating the integrity of the recorded data is therefore displayed.

The window 1100 includes a report data display region 1161. The details of the inspection report are displayed in the report data display region 1161. If there are many inspection reports, all the inspection reports can be displayed by scrolling the displayed screen vertically and horizontally. In the report data display region 1161, “span #25” is indicated as the span for which repairs are determined to be necessary. In this example, the type of the structure to be inspected is a tunnel, and the unit to be inspected is “span”. “Span #25” indicates the 25th span. As described above, the inspection report data may include access path information for the image data, defect data, and difference determination data corresponding to “span #25” as attribute information. To that end, a hyperlink to the data may be displayed in the report data display region 1161.

Crack extension distance represents the total length of the segments of a crack defect that has newly formed in a specific span between the previous inspection and the current inspection. Width increase number represents the ratio of the number of defects that have increased in width to the number of defects detected in the current inspection, for the specific span. Once the review is complete, the user presses the “OK” button 1126. The sequence then moves to step S1220.

Step S1219 is performed when an alteration is determined to have been made (F) in the alteration verification process. In this case, a message indicating that the data may have been altered is displayed in the window 1100 of the inspection app 200. Furthermore, after step S1219, the user is logged out in step S1220. This prevents the next process from being performed using data that may have been altered.

FIG. 11M illustrates an example of a screen displayed in the window 1100 when it is determined in step S1217 that the data has been altered (F). A message 1113 reading “possible unauthorized alteration” is displayed in the display region 1110. In this manner, a warning is provided indicating that the displayed inspection report may have been altered. The message 1113 may be a hyperlink to the data that has been determined to have been altered. In the alteration verification record data 900, Verification Result 908 for the data that may have been altered is “F”, indicating that the data may have been altered. The storage location of such data is specified by Verified Data URI 901 in the alteration verification record data 900. The message 1113 reading “possible unauthorized alteration” is also displayed in the display region 1110 when data is determined to have been altered (F) in another step.

In step S1220, the user authentication unit 308 logs out the user who was authenticated in step S1201. The user is logged out as a result. The processing illustrated in FIG. 12 then ends.

An example of the alteration verification process performed by the verification processing unit 313 will be described next with reference to the flowchart in FIG. 13. As described above, the verification processing unit 313 can verify whether the inspection data, such as the defect data, the image data, the difference determination data, and the inspection report data, has been altered. The verification processing unit 313 can also verify whether the inspection processing transaction data and the alteration verification record data has been altered.

In step S1301, the verification processing unit 313 obtains, from the inspection processing transaction data 800, Recorded Data URI 801 for the data subject to alteration verification. The verification processing unit 313 can select each piece of data indicated in the inspection processing transaction data 800 in sequence as the data subject to alteration verification. Note that the defect data may be corrected in the defect information correction process. In this case, a history having the same Recorded Data URI 801, and having “defect information” as Recorded Data Type 802, is registered in duplicate in the inspection processing transaction data 800. As such, in the present embodiment, the verification processing unit 313 obtains Recorded Data Hash Value 807, Recording Process 805, and Recording Date/Time 806 from the history having the newest Recording Date/Time 806 among the duplicate histories, as will be described later.

In step S1302, the verification processing unit 313 obtains, from the inspection processing transaction data 800, Recorded Data Hash Value 807 for the data subject to alteration verification. In step S1303, the verification processing unit 313 obtains the data to be verified, indicated by the recorded data URI obtained in step S1301.

In step S1304, the verification processing unit 313 obtains the hash value of the data obtained in step S1303. Furthermore, the hash value calculation unit 310 can calculate a hash value of the data through the same method as that used when recording inspection processing transaction data. The verification processing unit 313 obtains the hash value calculated by the hash value calculation unit 310.

In step S1305, the verification processing unit 313 compares the hash value obtained in step S1302 with the hash value obtained in step S1304. If the values match, the sequence moves to step S1308. If the values do not match, the sequence moves to step S1309.

In step S1308, the verification processing unit 313 determines that the data indicated by the recorded data URI obtained in step S1301 has not been altered. In this case, the verification result is “T”. The sequence then moves to step S1310.

In step S1309, the verification processing unit 313 determines that the data indicated by the recorded data URI obtained in step S1301 has been altered. In this case, the verification result is “F”. The sequence then moves to step S1310.

In step S1310, the verification recording unit 311 records the verification result in the verification record database 206. For example, the verification recording unit 311 records the recorded data URI obtained in S1301 as Verified Data URI 901 in the alteration verification record data 900. Recorded Data Type 802 and Structure ID 803 included in the inspection processing transaction data 800 are recorded as Recorded Data Type 902 and Structure ID 903. The username of the logged-in user, held by the user authentication unit 308, is recorded as User ID 904. The current date/time is recorded as Verification Date/Time 905. The hash value obtained in step S1302 is recorded as Obtained Data Hash Value 906. The hash value calculated in step S1304 is recorded as Confirmation Calculation Hash Value 907. The verification result from step S1308 or step S1309 is recorded as Verification Result 908. The hash value of the concatenated data obtained by concatenating Verified Data URI 901 to Verification Result 908 as described above is recorded as Verification Record Hash Value 909. The sequence then moves to step S1311.

In step S1311, the verification processing unit 313 determines whether the verification processing has ended for all of the unique data in the inspection processing transaction data 800. If unprocessed data remains, the sequence loops back to step S1301. If all the data has been processed, the sequence in FIG. 13 ends.

The foregoing embodiment described the hash values of the data as being recorded in the transaction database 205 or the like. For example, the inspection processing transaction data and the alteration verification record data were described as being stored in the transaction database 205 and the verification record database 206. On the other hand, this data may be recorded in a blockchain.

Managing data using a blockchain, which is a distributed ledger management system, has begun in recent years. Blockchain is system that maintains the consistency of data by using a hash mechanism, encryption technology, and P2P multinode distributed management technology to manage data. The blockchain has a structure in which blocks are connected in the form of a chain. Each block is a piece of data. Each block holds a hash value unique to the previous block connected in the chain. As such, if a block is altered, the hash values of all subsequent connected blocks will be inconsistent. It is therefore necessary to modify all the blocks in order to conceal the alteration. This is difficult to accomplish, which makes blockchain extremely resistant to such alterations. Furthermore, the nodes that hold the blockchain are distributed redundantly, which makes the blockchain highly resilient. To connect blocks in the blockchain, it is necessary to calculate a parameter required by the hash calculation, called a “nonce”. The computational difficulty of the nonce is one of the reasons why the blockchain is difficult to alter. Alterations can also be detected and prevented by recording data such as that described above in a blockchain ledger.

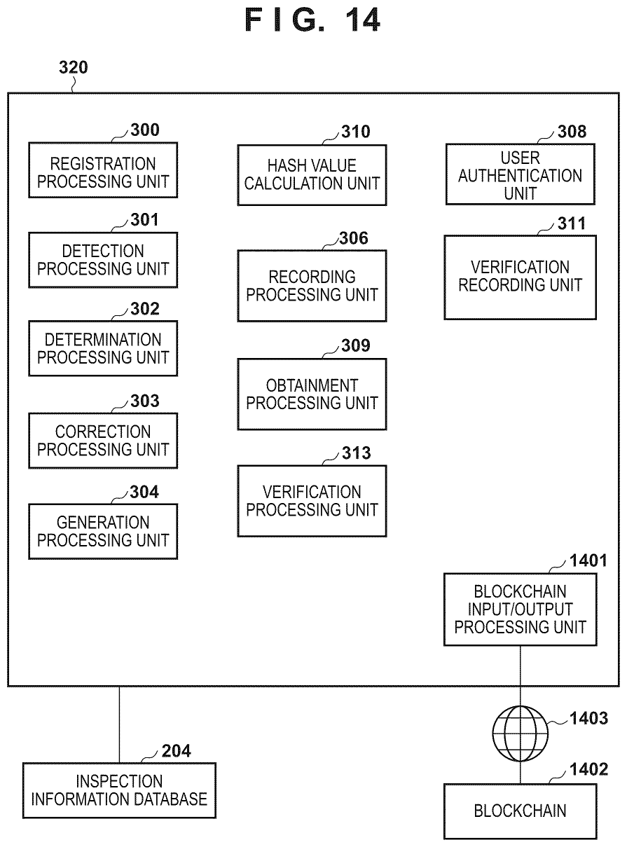

FIG. 14 is a diagram illustrating an example of the software configuration of the server apparatus 320 according to such an embodiment. Configurations that are the same as in FIG. 3 are given the same reference signs. The recording processing unit 306 records the inspection data in the inspection information database 204 as described above, and registers the hash value of the inspection data in a blockchain 1402. For example, the recording processing unit 306 can register a hash value of inspection data, such as the defect data, calculated by the hash value calculation unit 310, in the blockchain. Specifically, the recording processing unit 306 can register the inspection processing transaction data 800 in the blockchain 1402 as described above through a blockchain input/output processing unit 1401. The recording processing unit 306 may also register the hash value of the inspection processing transaction data 800 calculated by the hash value calculation unit 310 in the blockchain 1402 in association with the inspection processing transaction data 800. At this time, the hash value calculation unit 310 may use a hash function specified by the blockchain 1402.

The blockchain 1402 is a distributed ledger management system connected to the blockchain input/output processing unit 1401 by an Internet line 1403. However, the blockchain 1402 may be a service built on the same private network as the server apparatus 320. The blockchain input/output processing unit 1401 may be a blockchain accessor for recording data in the blockchain 1402 and reading out data from the blockchain 1402. Such a blockchain accessor serves as a broker that links with the blockchain 1402 using an API. The blockchain accessor may be connected to the management server 203. In this case, the management server 203 can hold the public keys and private keys required to record digital signatures in the blockchain as blockchain credentials. When registering data in the blockchain, the blockchain accessor obtains the public key held in the blockchain credentials in the management server 203.

The verification processing unit 313 obtains the hash value registered in the blockchain 1402 through the blockchain input/output processing unit 1401. For example, the obtainment processing unit 309 can obtain the hash value of inspection data, such as the defect data, from the blockchain. Using the obtained hash value, the verification processing unit 313 can verify whether inspection data, such as the defect data, has been altered. Additionally, using the obtained hash value, the verification processing unit 313 can verify whether alterations have been made after the inspection processing transaction data was registered. The verification recording unit 311 can also register the result of the verification by the verification processing unit 313 in the blockchain 1402 in the same manner through the blockchain input/output processing unit 1401.

In the foregoing example, the blockchain 1402 is used instead of the transaction database 205 and the verification record database 206. The server apparatus 320 includes the inspection information database 204. However, the method for using the blockchain is not limited to this example. For example, the inspection data may be registered in the blockchain 1402 instead of the inspection information database 204.

According to the embodiment as described above, alterations to inspection data such as defect data can be detected. This makes it difficult to alter the inspection data. The reliability of the inspection data can therefore be increased. In particular, situations where an inspection worker or construction worker alters inspection data for a structure by increasing or reducing the number of defects detected, the number of locations requiring repairs, and the like can be suppressed, which makes it possible to increase the reliability of the inspection results.

### Variation

The verification of data alteration by the verification processing unit 313 may be performed through a different method. The method for verifying alterations may also differ from data to data. In the present variation, whether data has been altered is verified based on whether a correction to the data is determined to have been made within an allowed correction period.

There are situations where the defect data generated by the detection processing unit 301 is corrected multiple times by the correction processing unit 303. For example, a user may review and correct defect data on a given day, and then may review and correct the defect data again on a different day. To lighten the processing load and reduce the amount of data, when the correction processing unit 303 corrects the defect data and the recording processing unit 306 records the corrected defect data, the recording processing unit 306 may skip recording the hash value of the corrected defect data. In this case, the recording processing unit 306 may skip recording transaction data indicating the history of the processes for correcting the defect data. In this case, if the user has entered an instruction to complete the correction of the defect data, the recording processing unit 306 may record the hash value of the defect data after the correction is complete. However, in such a variation, the hash value of the corrected defect data will not match the hash value of the defect data recorded previously, prior to the correction being complete.

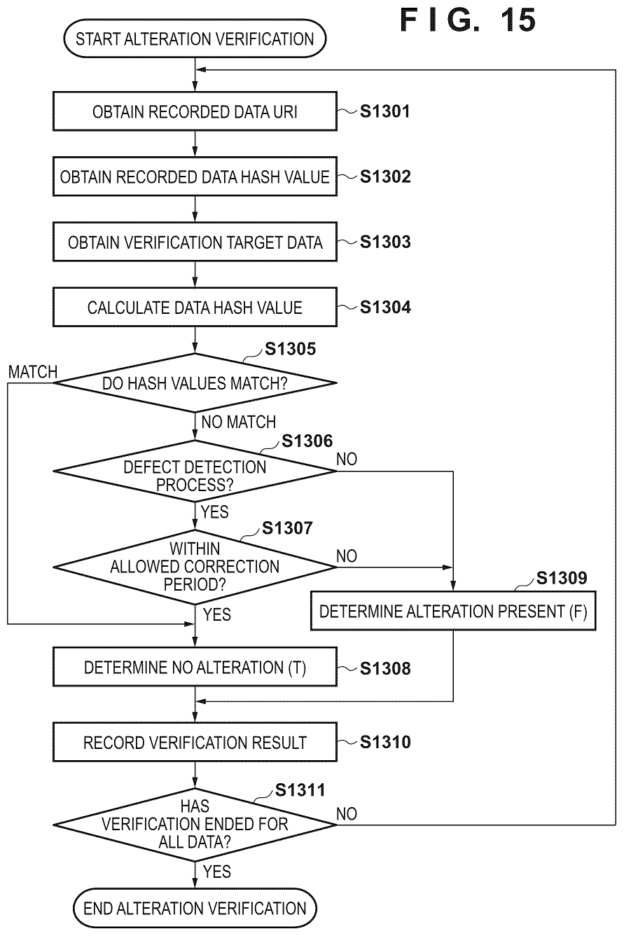

In such a variation, the verification processing unit 313 can verify whether various types of data have been altered according to the flowchart illustrated in FIG. 15. In FIG. 15, steps that are the same as those in FIG. 13 are indicated by the same reference signs. In this example, if the hash values are determined not to match in step S1305, the sequence moves to step S1306.

In step S1306, the verification processing unit 313 determines whether data subject to alteration verification has been registered in the defect detection process. For example, the verification processing unit 313 obtains, from the inspection processing transaction data 800, Recording Process 805 for the data subject to alteration verification. If Recording Process 805 is “defect detection”, the data subject to alteration verification is registered in the defect detection process. If the data subject to alteration verification has been registered in the defect detection process, the sequence moves to step S1307. If not, the sequence moves to step S1309.

In step S1307, the data subject to alteration verification is the defect data generated in the defect detection process. However, this defect data has been corrected. Accordingly, the hash value for the corrected defect data, obtained in steps S1303 and S1304, and the hash value of the defect data, obtained in step S1302, are determined not to match in step S1305. Here, the verification processing unit 313 determines whether the correction to the defect data was made within the allowed correction period. To that end, the verification processing unit 313 obtains, from the inspection processing transaction data 800, Recording Date/Time 806 for the data subject to alteration verification. Recording Date/Time 806 indicates the recording time of the defect data before the correction, i.e., the date/time when the defect detection process was performed, and is used as the starting time of the allowed correction period. A date/time obtained by adding a predetermined correction period to the starting time of the allowed correction period is used as the ending time of the allowed correction period.

If the current date/time is before the ending time of the allowed correction period, the verification processing unit 313 determines that the correction to the defect data was made within the allowed correction period. In this case, the verification processing unit 313 determines that the defect data has not been altered. Here, the sequence moves to step S1308. However, if the current date/time is after the ending time of the allowed correction period, it is possible that the correction to the defect data was not made within the allowed correction period. If the correction to the defect data was made significantly later than the defect detection process, it is highly likely that the defect data was altered. Accordingly, if the correction to the defect data is not determined to have been made within the allowed correction period, the verification processing unit 313 determines that the defect data has been altered. In this case, the sequence moves to step S1309.

Note that the verification processing unit 313 may make the determination described above using information indicating the recording date/time of the corrected defect data, such as a timestamp, instead of the current date/time.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-174628, filed Oct. 6, 2023, which is hereby incorporated by reference herein in its entirety.

What is claimed is:

1. An information processing apparatus comprising:
one or more memories storing instructions; and
one or more processors that execute the instructions to:
detect a defect in a structure based on an image of the structure and generate defect data indicating a detection result,
calculate a hash value of the defect data,
record the defect data and the calculated hash value of the defect data,
perform first obtainment processing of obtaining the recorded defect data and the recorded hash value of the defect data,
perform first calculation processing of calculating a hash value of the defect data obtained in the first obtainment processing, and
verify whether the defect data obtained in the first obtainment processing has been altered by comparing the hash value of the defect data calculated in the first calculation processing with the hash value of the defect data obtained in the first obtainment processing.

2. The information processing apparatus according to claim 1, wherein the one or more processors further execute the instructions to:
correct the defect data obtained in the first obtainment processing; and
verify that the corrected defect data has been corrected within an allowed correction period,
wherein the allowed correction period is a predetermined period from the recording of the defect data before the correcting.

3. The information processing apparatus according to claim 1, wherein the one or more processors further execute the instructions to:
correct the defect data obtained in the first obtainment processing;
record the corrected defect data and a hash value of the corrected defect data;
perform second obtainment processing of obtaining the recorded corrected defect data and the recorded hash value of the corrected defect data;
perform second calculation processing of calculating a hash value of the corrected defect data obtained in the second obtainment processing; and
verify whether the corrected defect data obtained in the second obtainment processing has been altered by comparing the hash value of the corrected defect data calculated in the second calculation processing with the hash value of the corrected defect data obtained in the second obtainment processing.

4. The information processing apparatus according to claim 1, wherein the one or more processors further execute the instructions to:
record transaction data indicating a history of processes for detecting a defect in the structure.

5. The information processing apparatus according to claim 4,
wherein the transaction data indicates a storage location of the defect data and the hash value of the defect data.

6. The information processing apparatus according to claim 4, wherein the one or more processors further execute the instructions to:
record a hash value of the transaction data.

7. The information processing apparatus according to claim 1, wherein the one or more processors further execute the instructions to:
determine a difference in the defect indicated by a plurality of pieces of the defect data obtained, and generate difference determination data indicating the result of determination;
record the difference determination data and a hash value of the difference determination data;
perform third obtainment processing of obtaining the recorded difference determination data and the recorded hash value of the difference determination data;
perform third calculation processing of calculating a hash value of the difference determination data obtained in the third obtainment processing; and
verify whether the difference determination data obtained in the third obtainment processing has been altered by comparing the hash value of the difference determination data calculated in the third calculation processing with the hash value of the difference determination data obtained in the third obtainment processing.

8. The information processing apparatus according to claim 7, wherein the one or more processors further execute the instructions to:
accept a registration of an image of the structure;
record a hash value of data of the image of the structure;
perform fourth obtainment processing of obtaining the data of the registered image and the recorded hash value of the data of the image;
perform fourth calculation processing of calculating a hash value of the data of the image obtained in the fourth obtainment processing; and
verify whether the data of the image obtained in the fourth obtainment processing has been altered by comparing the hash value of the data of the image calculated in the fourth calculation processing with the hash value of the data of the image obtained in the fourth obtainment processing.

9. The information processing apparatus according to claim 8, wherein the one or more processors further execute the instructions to:
generate inspection report data of the structure based on the difference determination data,
wherein the inspection report data is generated in response to determining that the difference determination data obtained in the third obtainment processing, the plurality of pieces of the defect data used to generate the difference determination data, and a plurality of pieces of the data of the image used to generate the plurality of pieces of the defect data have not been altered.

10. The information processing apparatus according to claim 9, wherein the one or more processors further execute the instructions to:
record the inspection report data and a hash value of the inspection report data.

11. The information processing apparatus according to claim 1, wherein the one or more processors further execute the instructions to:
register the hash value of the defect data in a blockchain; and
obtain the hash value of the defect data from the blockchain in the first obtainment processing.

12. The information processing apparatus according to claim 1, wherein the one or more processors further execute the instructions to:
record data generated during processing performed by the information processing apparatus for inspecting the structure, and a hash value of the data;
perform fifth obtainment processing of obtaining the recorded data and the hash value of the data;
perform fifth calculation processing of calculating a hash value of the data obtained in the fifth obtainment processing;
verify whether the data obtained in the fifth obtainment processing has been altered by comparing the hash value of the data calculated in the fifth calculation processing with the hash value of the data obtained in the fifth obtainment processing; and
perform specific processing for inspecting the structure in response to determining that data used in the specific processing have not been altered.

13. The information processing apparatus according to claim 12, wherein the one or more processors further execute the instructions to:
perform the specific processing in response to determining that data used to generate the data used in the specific processing, as well as the data used in the specific processing, have not been altered.

14. The information processing apparatus according to claim 1, wherein the one or more processors further execute the instructions to:
record transaction data indicating a history of processes performed by the information processing apparatus to inspect the structure.

15. The information processing apparatus according to claim 14,
wherein the transaction data indicates a storage location of data recorded during the processes for inspecting the structure, and a hash value of the data.

16. The information processing apparatus according to claim 15,
wherein the transaction data further indicates a type of the data, a process in which the data was recorded, and a recording time of the data.

17. The information processing apparatus according to claim 14, wherein the one or more processors further execute the instructions to:
register the transaction data in a blockchain.

18. An information processing method comprising:
detecting a defect in a structure based on an image of the structure and generating defect data indicating a detection result;
calculating a hash value of the defect data;
recording the defect data and the calculated hash value of the defect data;
performing first obtainment processing of obtaining the recorded defect data and the recorded hash value of the defect data;
performing first calculation processing of calculating a hash value of the defect data obtained in the first obtainment processing; and
verifying whether the defect data obtained in the first obtainment processing has been altered by comparing the hash value of the defect data calculated in the first calculation processing with the hash value of the defect data obtained in the first obtainment processing.

19. A non-transitory computer-readable medium storing computer-executable instructions that, when executed by a computer, cause the computer to perform a method comprising:
detecting a defect in a structure based on an image of the structure and generating defect data indicating a detection result;
calculating a hash value of the defect data;
recording the defect data and the calculated hash value of the defect data;
performing first obtainment processing of obtaining the recorded defect data and the recorded hash value of the defect data;
performing first calculation processing of calculating a hash value of the defect data obtained in the first obtainment processing; and
verifying whether the defect data obtained in the first obtainment processing has been altered by comparing the hash value of the defect data calculated in the first calculation processing with the hash value of the defect data obtained in the first obtainment processing.
